(19) United States
(12) Patent Application Publication
(10) Pub. No.: US 2003/0161942 A1
(43) Pub. Date: Aug. 28, 2003

(54) Methods of manufacturing electron-emitting device, electron source, and image-forming apparatus

(75) Inventors: Yutaka Arai, Kanagawa (JP); Hironobu Mizuno, Kanagawa (JP); Takashi Iwaki, Tokyo (JP); Koki Nukanobu, Kanagawa (JP); Tsuyoshi Takegami, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/370,662

(22) Filed: Feb. 24, 2003

(30) Foreign Application Priority Data
Feb. 28, 2002 (JP) 054170/2002
Jan. 17, 2003 (JP) 008971/2003

(51) Int. Cl. B05D 3/00; B05D 5/12

(52) U.S. Cl. 427/77; 427/555

(57) ABSTRACT

A method of manufacturing an electron-emitting device is provided in which steps can be simplified and which enables and improvement of electron-emitting characteristics. This manufacturing method comprises the steps of: providing substrate on which a pair of electrodes and a polymer film of connecting the pair of electrodes are arranged, wherein the polymer film contains a polymer and a substance with a characteristic of light absorption; irradiating light to the polymer film, to lower resistance of the polymer film; and forming a gap in a film obtained by lowering the resistance of the polymer film.

### BACKGROUND OF THE INVENTION

1. Field of the Invention

The present invention relates to a method of manufacturing an electron-emitting device, a method of manufacturing an electron source structured by arranging a large number of electron-emitting devices, and a method of manufacturing an image-forming apparatus, such as a display apparatus, which is structured by using the electron source.

2. Related Background Art

Up to now, a surface conduction electron-emitting device has been known as an electron-emitting device.

A structure, a manufacturing method, and the like of the surface conduction electron-emitting device are disclosed, for example, in Japanese Patent Application Laid-open No. 8-321254.

A structure of a typical surface conduction electron-emitting device disclosed in the above-mentioned publication or the like is schematically shown in FIGS. 46A and 46B, which are respectively a plan view and a sectional view of the surface conduction electron-emitting device disclosed in the above-mentioned publication or the like.

In FIGS. 46A and 46B, reference numeral 461 denotes a substrate, 462 and 463 denote a pair of electrodes facing each other, 464 denotes a conductive film, 465 denotes a second gap, 466 denotes a carbon film, and 467 denotes a first gap.

An example of a manufacturing process of the electron-emitting device constructed as in FIGS. 46A and 46B is schematically shown in FIGS. 47A to 47D.

The pair of electrodes 462 and 463 are first formed on the substrate 461 (FIG. 47A).

Subsequently, the conductive film 464 for connecting between the electrodes 462 and 463 is formed (FIG. 47B).

Then, a current is made to flow between the electrodes 462 and 463, and the so-called “forming step” is performed for forming the second gap 465 in a part of the conductive film 464 (FIG. 47C).

Further, in a carbon compound atmosphere, a voltage is applied between the electrodes 462 and 463 to perform the so-called “activation step”,by which the carbon film 466 is formed on a part of the substrate 461 within the area of the second gap 465 and is also formed on a part of the-conductive film 464 in the vicinity of the second gap 465, resulting in an electron-emitting device (FIG. 47D).

On the other hand, another method of manufacturing a surface conduction electron-emitting device is disclosed in Japanese Patent Application Laid-Open No. 9-237571.

An image-forming apparatus such as a flat display panel can be structured by combining an electron source structured by arranging a plurality of electron-emitting devices formed in accordance with the above-described manufacturing method and an image-forming member comprised of a phosphor or the like.

In the above-described conventional device, an “activation step” and the like are performed in addition to a “forming step”, whereby, in the inside of the second gap 465 formed by the “forming step”, the carbon film 466, which is formed of carbon or a carbon compound and which has the first gap 467 narrower than the second gap 465. Consequently, good electron emission characteristics are obtained.

### SUMMARY OF THE INVENTION

However, manufacturing of an image-forming apparatus that uses such a conventional electron-emitting device has the following problems.

That is, the manufacturing method includes many additional steps such as repeated energization steps in the “forming step” and the “activation step” and a step of forming a preferable atmosphere in each step, and thus, management of respective steps has been complicated.

Further, in the case where the electron-emitting device is used for an image-forming apparatus such as a display, further improvement in electron-emitting characteristics is desired in order to reduce power consumption of the apparatus.

Moreover, it is desired that the image-forming apparatus that uses the electron-emitting device is manufactured easier and simpler and at lower cost.

The present invention has been made in view of the above, and therefore has an object to provide a method of manufacturing an electron-emitting device which particularly attains simplification of manufacturing steps of the electron-emitting device and improvement of electron-emitting characteristics, a method of manufacturing an electron source, and a method of manufacturing an image-forming apparatus.

The present invention has been made as a result of extensive studies for solving the above-mentioned problems and has the structures described below.

That is, according to a first aspect of the present invention, there is provided a method of manufacturing an electron-emitting device, the method comprising steps of:

providing substrate on which a pair of electrodes and a polymer film of connecting the pair of electrodes are arranged, wherein the polymer film contains a polymer and a substance with a characteristic of light absorption;

irradiating light to the polymer film, to lower resistance of the polymer film; and

forming a gap in a film obtained by lowering the resistance of the polymer film.

Further, there is provided the method of manufacturing the electron-emitting device, wherein the above step of providing the substrate further comprising a step of applying a solution containing a precursor of the polymer and the substance on the substrate.

Further, there is provided the method of manufacturing the electron-emitting device wherein the precursor of the polymer contains polyamide acid.

According to a second aspect of the present invention, there is provided a method of manufacturing an electron-emitting device, the method comprising the steps of:

providing a substrate on which a pair of electrodes, a polymer film of connecting the pair of electrodes and a layer containing a substance with a characteristic of light absorption of the polymer film are arranged;

irradiating light to the layer and the polymer film, to lower resistance of the polymer film; and

forming a gap in a film obtained by lowering the resistance of the polymer film.

According to a third aspect of the present invention, there is provided a method of manufacturing an electron-emitting device, the method comprising the steps of:

forming a pair of electrodes in first and second regions on a substrate, respectively;

providing a layer containing a substance with a characteristic of light absorption between the regions;

providing a polymer film connecting the electrodes;

irradiating light to the polymer film connecting the electrodes;

irradiating light to the polymer film and the layer, to lower resistance of the polymer film; and

forming a gap in a film obtained by lowering the resistance of the polymer film.

The method of manufacturing an electron-emitting device according to the second and third aspects of the present invention includes, as preferred aspects, “that non-metal having an optical absorption edge is used as the substance with the characteristic of light absorption (light absorber)”, “that a semiconductor is used as the light absorber”, “that a multi-compound semiconductor is used as the light absorber”, “that an insulator is used as the light absorber”, and “that a material having an optical trap level in a band gap is used as the light absorber”.

According to a fourth aspect of the present invention, there is provided a method of manufacturing an electron-emitting device, the method comprising the steps of:

providing a pair of electrodes on a substrate having a characteristic of light absorption;

providing a polymer film connecting the electrodes;

irradiating light to the polymer film, to lower resistance of the polymer film; and

forming a gap in a film obtained by lowering the resistance of the polymer film.

In the above-described methods of manufacturing an electron-emitting device according to the present invention, laser or light emitted from a xenon lamp or halogen lamp is preferably used as the light.

Further, according to a fifth aspect of the present invention, there is provided a method of manufacturing an electron-emitting device, the method comprising the steps of:

Providing a substrate on which a polymer film, containing a polymer and a substance expediting thermal decomposition of the polymer;

irradiating an energy beam to the polymer film, to lower resistance of the polymer film; and

forming a gap in a film obtained by lowering the resistance of the polymer film.

The method of manufacturing an electron-emitting device according to the fifth aspect of the present invention includes, as preferred aspects, “that the energy beam is selected from a group consisting of an electron beam, an ion beam, condensed light, and a laser beam”, “that the substance expediting thermal decomposition contains metal” and “that the metal is selected from a group consisting of Pt, Pd, Ru, Cr, Ni, Co, Ag, In, Cu, Fe, Zn, and Sn”.

Further, according to a sixth aspect of the present invention, thereis provided a method of manufacturing an electron-emitting device, the method comprising the steps of:

Providing a substrate on which a polymer film is disposed;

Causing the polymer film to absorb a substance expediting a thermal decomposition of the polymer;

Lowering resistance of the polymer film containing the substance; and

Forming a gap in a film obtained by lowering the resistance of the polymer film containing the substance.

The method of manufacturing an electron-emitting device according to the sixth aspect of the present invention includes as preferred aspects:

“that the step of lowering resistance of the polymer film containing substance includes a step of baking the polymer film containing the substance”;

“that the step of lowering resistance of the polymer film containing the substance includes a step of irradiating an energy beam to the polymer film containing the substance from a position apart from the substrate”;

“that the energy beam is light”;

“that the energy beam is a laser beam”;

“that the energy beam is an electron beam”;

“that the energy beam is an ion beam”;

“that the step of causing the polymer film to absorb the substance includes a step of making the polymer film contact with a liquid containing a metal complex”; and

“that the metal is selected from the group consisting of Pt, Pd, Ru, Cr, Ni, Co, Ag, In, Cu, Fe, Zn, and Sn”.

Further, there is provided a method of manufacturing a display including a plurality of electron-emitting devices and a light emitting member for emitting light due to electrons emitted from the plurality of electron-emitting devices, characterized in that the plurality of electron-emitting devices are manufactured in accordance with the manufacturing method according to the sixth aspect of the present invention.

Moreover, according to the present invention, there is provided a method of manufacturing an electron source having a plurality of electron-emitting devices, characterized in that the plurality of electron-emitting devices are manufactured in accordance with the method of manufacturing an electron-emitting device according to the present invention.

Furthermore, according to the present invention, there is provided a method of manufacturing an image-forming apparatus (or display) including: an electron source having a plurality of electron-emitting devices; and an image-forming member (light emitting member) for forming an image with irradiation of electrons emitted from the electron source, characterized in that the electron source is manufactured in accordance with the method of manufacturing an electron source according to the present invention.

According to the present invention, steps can be greatly simplified in comparison with a conventional manufacturing method which requires a step of forming a conductive film, a step of forming a gap in the conductive film, a step of forming an atmosphere containing an organic compound (or a step of forming a polymer film on the conductive film), and a step of forming a gap in a carbon film while simultaneously forming the carbon film through energization of a conductive film. In addition, according to the present invention, the step of subjecting a polymer film to resistance lowering, which is described below, for making a light absorber efficiently absorb light, can be effectively completed for a short time. Further, since a polymer film (resulted in a carbon film) that constitutes an electron-emitting device has satisfactory heat-resistance, this enables improvement of electron-emitting characteristics which has been limited due to heat-resistance of a conductive film in the prior art.

Furthermore, the present invention is not limited to the method of manufacturing the carbon film of the surface conductive electron-emitting device. The present invention's manufacturing method can also be used for various types of electronic devices such as an electron-emitting device or a cell (rechargeable (secondary) battery such as lithium-ion batteries or the like) that uses a carbon film, or a film used in various types of electronic equipments. Thus, in the case that the present invention's manufacturing method is used for the electronic devices or film other than the surface conductive electron-emitting device, it is sufficient to have a step of disposing on a substrate a polymer film containing a substance expediting a thermal decomposition or a substance with a characteristic of light absorption, or a step of disposing on the substrate a laminated body which consists of a layer containing the substance expediting the thermal decomposition or the substance with the characteristic of light absorption and the polymer film, and a step of irradiating an energy beam (as under-mentioned) to the polymer film.

### BRIEF DESCRIPTION OF THE DRAWINGS

FIGS. 1A and 1B are respectively a plan view and a sectional view schematically showing a structural example of an electron-emitting device according to the present invention;

FIGS. 2A and 2B are respectively a plan view and a sectional view schematically showing another structural example of an electron-emitting device according to the present invention;

FIGS. 3A, 3B, 3C and 3D are sectional views schematically showing an example of a method of manufacturing an electron-emitting device according to the present invention;

FIGS. 4A, 4B and 4C are plan views schematically showing an example of a resistance lowering step in a method of manufacturing an electron-emitting device according to the present invention;

FIG. 5 is a schematic diagram showing an example of a vacuum apparatus equipped with a measurement-evaluation function for an electron-emitting device;

FIG. 6 is a schematic diagram for explaining a manufacturing step of an electron source in accordance with Embodiment 1;

FIG. 7 is a schematic diagram for explaining a manufacturing step of the electron source in accordance with Embodiment 1;

FIG. 8 is a schematic diagram for explaining a manufacturing step of the electron source in accordance with Embodiment 1;

FIG. 9 is a schematic diagram for explaining a manufacturing step of the electron source in accordance with Embodiment 1;

FIG. 10 is a schematic diagram for explaining a manufacturing step of the electron source in accordance with Embodiment 1;

FIG. 11 is a schematic diagram for explaining a manufacturing step of the electron source in accordance with Embodiment 1;

FIG. 12 is a schematic diagram for explaining a manufacturing step of the electron source in accordance with Embodiment 1;

FIG. 13 is a schematic diagram for explaining a manufacturing step of an electron source in accordance with Embodiment 2;

FIGS. 14A and 14B are schematic diagrams showing an example of a manufacturing step of an image-forming apparatus according to the present invention;

FIGS. 15A and 15B are respectively a plan view and a sectional view schematically showing another structural example of an electron-emitting device according to the present invention;

FIGS. 16A, 16B, 16C, 16D and 16E are sectional views schematically showing a method of manufacturing an electron-emitting device in FIGS. 15A and 15B;

FIGS. 17A and 17B are respectively a plan view and a sectional view schematically showing another structural example of an electron-emitting device according to the present invention;

FIGS. 18A and 18B are respectively a plan view and a sectional view schematically showing another structural example of an electron-emitting device according to the present invention;

FIGS. 19A and 19B are respectively a plan view and a sectional view schematically showing another structural example of an electron-emitting device according to the present invention;

FIG. 20 is a schematic diagram for explaining a manufacturing step of an electron source in accordance with Embodiment 4;

FIG. 21 is a schematic diagram for explaining a manufacturing step of the electron source in accordance with Embodiment 4;

FIG. 22 is a schematic diagram for explaining a manufacturing step of the electron source in accordance with Embodiment 4;

FIG. 23 is a schematic diagram for explaining a manufacturing step of the electron source in accordance with Embodiment 4;

FIG. 24 is a schematic diagram for explaining a manufacturing step of the electron source in accordance with Embodiment 4;

FIG. 25 is a schematic diagram for explaining a manufacturing step of the electron source in accordance with Embodiment 4;

FIG. 26 is a schematic diagram for explaining a manufacturing step of the electron source in accordance with Embodiment 4;

FIGS. 27A, 27B, 27C, 27D, 27E and 27F are schematic diagrams for explaining manufacturing steps of the electron source in accordance with Embodiment 4;

FIG. 28 is a schematic diagram for explaining a manufacturing step of an electron source in accordance with Embodiment 3;

FIG. 29 is a schematic diagram for explaining a manufacturing step of the electron source in accordance with Embodiment 3;

FIG. 30 is a schematic diagram for explaining a manufacturing step of the electron source in accordance with Embodiment 3;

FIG. 31 is a schematic diagram for explaining a manufacturing step of the electron source in accordance with Embodiment 3;

FIG. 32 is a schematic diagram for explaining a manufacturing step of the electron source in accordance with Embodiment 3;

FIG. 33 is a schematic diagram for explaining a manufacturing step of the electron source in accordance with Embodiment 3;

FIG. 34 is a schematic diagram for explaining a manufacturing step of the electron source in accordance with Embodiment 3;

FIGS. 35A, 35B, 35C, 35D, 35E and 35F are schematic diagrams for explaining manufacturing steps of the electron source in accordance with Embodiment 3;

FIG. 36 is a schematic diagram for explaining a manufacturing step of an electron source in accordance with Embodiment 5;

FIG. 37 is a schematic diagram for explaining a manufacturing step of the electron source in accordance with Embodiment 5;

FIG. 38 is a schematic diagram for explaining a manufacturing step of the electron source in accordance with Embodiment 5;

FIG. 39 is a schematic diagram for explaining a manufacturing step of the electron source in accordance with Embodiment 5;

FIG. 40 is a schematic diagram for explaining a manufacturing step of the electron source in accordance with Embodiment 5;

FIG. 41 is a schematic diagram for explaining a manufacturing step of the electron source in accordance with Embodiment 5;

FIG. 42 is a schematic diagram for explaining a manufacturing step of the electron source in accordance with Embodiment 5;

FIGS. 43-0 and 43-1 and FIGS. 43A, 42B, 43C, 43D, 43E and 43F are schematic diagrams for explaining manufacturing steps of the electron source in accordance with Embodiment 5;

FIG. 44 is a schematic diagram showing an example of a vacuum apparatus equipped with a measurement-evaluation function for an electron-emitting device;

FIG. 45 is a schematic diagram showing electron-emitting characteristics of an electron-emitting device according to the present invention;

FIGS. 46A and 46B are schematic diagrams of a conventional electron-emitting device;

FIGS. 47A, 47B, 47C and 47D are schematic diagrams for explaining manufacturing steps of a conventional electron-emitting device;

FIG. 48 is a partially cutaway perspective view schematically showing a structural example of an image-forming apparatus according to the present invention;

FIG. 49 is a schematic diagram for explaining an electron beam irradiation apparatus according to the present invention; and

FIG. 50 is a schematic diagram for an ion beam irradiation apparatus according to the present invention.

### DESCRIPTION OF THE PREFERRED EMBODIMENTS

Hereinafter, description will be made of an embodiment of the present invention. However, the present invention is not limited to the embodiment.

Here, first, description will be simply made of a structure of an electron-emitting device manufactured according to the present invention, and then, description will be made of “about the use of a polymer film” and “about a substance expediting thermal decomposition” such as a substance with a characteristic of light absorption, which characterize the present invention. Thereafter, description will be made of methods of an electron-emitting device, an electron source, and an image-forming apparatus.

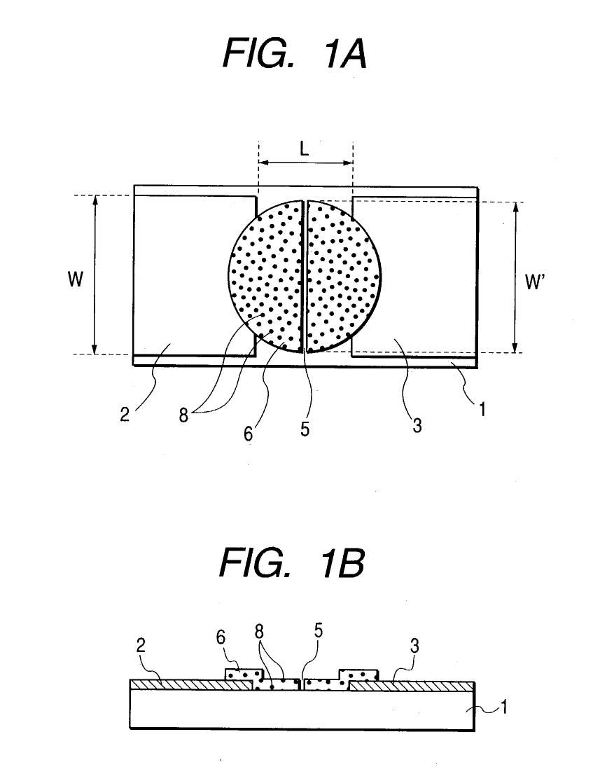

FIGS. 1A and 1B are diagrams schematically showing an example of the electron-emitting device manufactured in accordance with the manufacturing method according to the present invention. Note that FIG. 1A is a plan view and FIG. 1B is a sectional view on the assumption that the plane is substantially vertical to a surface of a substrate 1 on which electrodes 2 and 3 are arranged while passing therebetween.

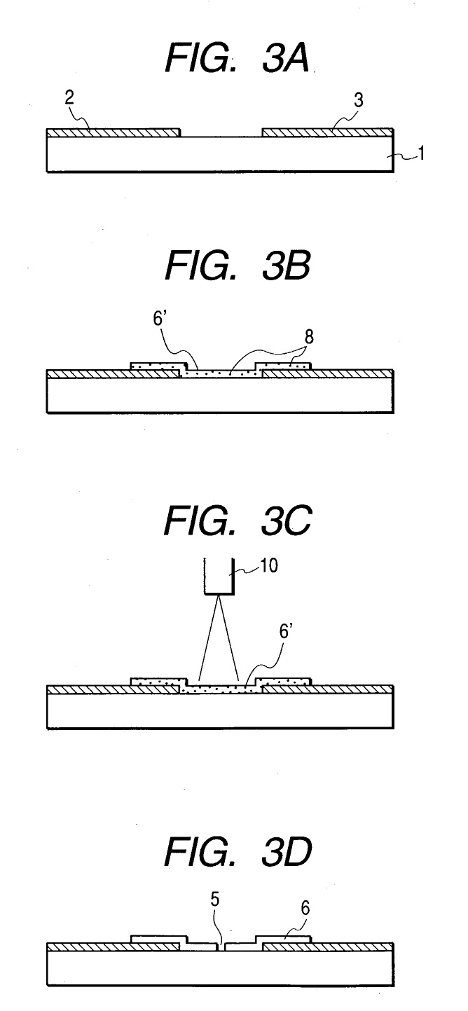

In FIGS. 1A and 1B, reference numeral 1 denotes the substrate (rear plate), 2 and 3 denote the electrodes, 6 denotes a carbon film, and 5 denotes a gap. In the figures, the carbon film 6 is arranged on the substrate 1 between the electrodes 2 and 3. As an example, which is shown in FIGS. 1A and 1B, of the method of manufacturing an electron-emitting device according to the present invention, the following one is given, for example. As shown in FIGS. 3A to 3D, for example, the electrodes 2 and 3 are formed on the substrate 1 (FIG. 3A), and then, an organic polymer film 6′ containing a substance expediting thermal decomposition 8 is arranged so as to connect between the electrodes 2 and 3 (FIG. 3B). Next, the polymer film 6′ containing the substance expediting thermal decomposition 8 is irradiated with an energy beam such as an electron beam, a laser beam, light (such as light emitted from a xenon lamp), or an ion beam from an energy beam irradiation means 10 which is positioned away from the substrate 1 so that the polymer film 6′ is carbonized (a “resistance lowering process” is performed) (FIG. 3C). Subsequently, the film 6 obtained by subjecting the polymer film 6′ to the resistance lowering process is flown with a current (a “voltage applying step” is performed) to form the gap 5.

In the electron-emitting device shown in FIG. 1A and FIG. 1B, when electric field is sufficiently applied to the gap 5, electrons tunnel through the gap 5 to cause a current to flow between the electrodes 2 and 3. The tunneled electrons partially scatter and then a part of the scattered electrons are drawn to an anode electrode (not shown) which is disposed above the substrate 1 due to a high voltage applied to the anode electrode.

The above “carbon film” 6 can be a “conductive film containing carbon as its main constituent”, a “conductive film having a gap in its part and containing carbon as its main constituent which electrically connects between a pair of electrodes”, or “a pair of conductive films containing carbon as its main ingredients”. Also, the “carbon film” 6 may be simply a “conductive film”. Alternatively, in connection with the process described below according to the present invention, the “carbon film” 6 is called a “film in which a polymer film is subjected to resistance lowering” or a “film obtained by subjecting a polymer film to resistance lowering” in some cases. However, when there is no particular difference in superiority in terms of crystallinity of carbon between the film obtained by performing the “resistance reducing (lowering) process” on the polymer film and a film obtained by applying a “voltage application step” to the film obtained by the “resistance reducing process”, although details thereof are described below, the following is specified. That is, in this case, the term “carbon film” and the term “film obtained by performing the resistance reducing (lowering) process on the polymer film” are used not for classifying films in terms of film quality but for classifying process stages.

In the electron-emitting device according to the present invention, it is required to lower resistance of polymer. Therefore, in the present invention, an electron beam, an ion beam, light, or the like is used for a resistance lowering process method although this will be described below in detail. Further, in order to facilitate the “resistance lowering process”, there is used a substance expediting thermal decomposition for expediting or assisting carbonization of the polymer at the time of the “resistance lowering process”. Note that the “carbonization” mentioned here in the present invention refers to formation (or increase) of a carbon six-membered ring system (hexagonal ring constituted from six carbon atoms), or increase of a carbon conjugated system, more specifically, formation (increase) of a state in which carbon six-membered ring systems are directly bonded to each other (graphitization is also included).

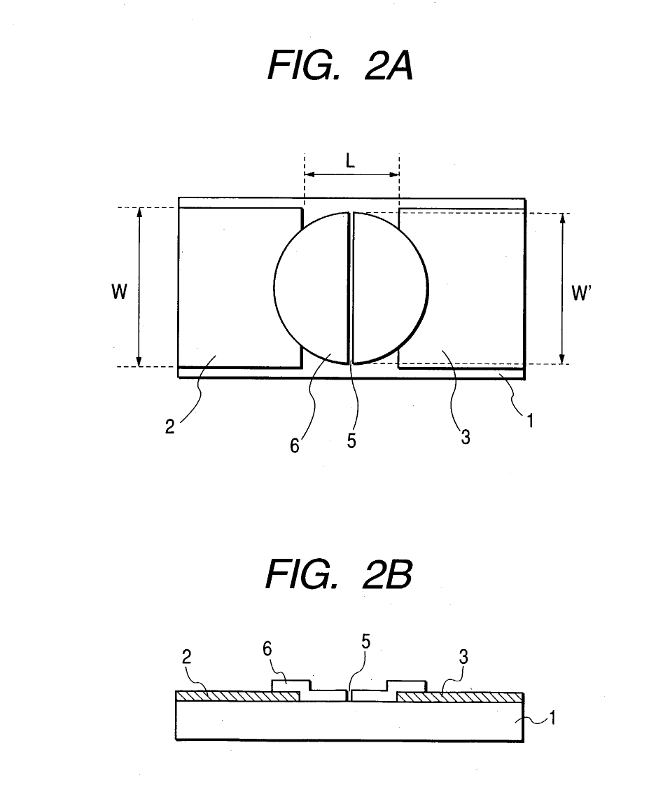

The carbon film 6 is, at the beginning, the film in which the substance expediting thermal decomposition 8 such as the substance with a characteristic of light absorption is mixed into the polymer film 6′ as is apparent from the manufacturing method described below. Note that an example is shown in FIGS. 1A and 1B in which the substance expediting thermal decomposition 8 remains in the carbon film 6. But, in some cases, the substance expediting thermal decomposition 8 is thermally decomposed (or disappeared) in manufacturing process (ex. the “resistance lowering process” such as light irradiation described below) as shown in FIGS. 2A and 2B. Whether the substance disappears or not is dependent on the substance expediting thermal decomposition to be used.

FIGS. 3A to 3D schematically show an example of a method of manufacturing the electron-emitting device of the present invention, which is shown in FIGS. 1A and 1B or FIGS. 2A and 2B. FIGS. 3A to 3D show a state in which the substance expediting thermal decomposition 8 such as the substance with a characteristic of light absorption (the light absorber) is dispersed in the polymer film 6′, but the substance expediting thermal decomposition 8 does not necessarily need to be dispersed. There is a case where the substance expediting thermal decomposition 8 such as the light absorber is dissolved in the polymer film 6′. The polymer film described above is subjected to the “resistance lowering (reducing) process”, whereby the substance expediting thermal decomposition 8 such as the light absorber accelerates decomposition and carbonization of the polymer film constituting the polymer film 6′. As a result, resistance lowering of the polymer film 6′ is attained.

Here, the “polymer film” in the present invention will be described.

Polymer (organic polymer) in the present invention refers to a compound with a molecular weight at which physical and chemical properties of the compound do not vary due to the molecular weight. A definite value of the lower limit of the molecular weight is not regulated. However, the polymer generally indicates a compound with a molecular weight of 5,000 or more, and preferably 10,000 or more in which molecules are bonded through covalent bonds.

The organic polymer used in the present invention is preferably a polymer having an aromatic ring in its main chain.

The polymer film in the present invention is preferably a polymer that expresses (increases) conductivity through the “resistance lowering process” described below. Above all, an aromatic polymer film having an aromatic ring in its backbone is preferable. This is because the aromatic polymer film originally has a structure similar to that of graphite having conductivity, and thus easily stores conjugated electrons.

Particularly in aromatic polyimide, an aromatic ring and an imido group exist in a planar shape in a backbone, and a structure similar to that of graphite is easily formed by the resistance lowering step of the present invention. Further, organic polymers such as polyphenylene oxadiazole and polyphenylene vinylene can be preferably used in the present invention.

The above-mentioned polymer generally exhibits insolubility to a solvent. Therefore, although aromatic polymers are preferably used in the present invention, most of the polymers are hard to be dissolved. Thus, a method of using a precursor solution of the polymer is preferable. When the precursor solution of the polymer is used to obtain a polymer film, the solution is applied on a substrate and then the substrate is heated to remove a solvent and to change the precursor to the polymer. An example is shown, in which a polyamic acid solution that is a precursor of aromatic polyimide is applied by an inkjet method or the like to a substrate thereby be formed into a polyimide film by heating or the like. The ink-jet method is suitable for a large substrate because the method can be applying a necessary amount of the solution onto a necessary positions in the surface of the substrate.

Note that, as a solvent for dissolving polyamic acid, for example, N-methylpyrrolidone, N,N-dimethyl acetamide, N,N-dimethyl formamide, dimethyl sulfoxide, or the like may be used. In addition, n-butyl cellosolve, triethanolamine, or the like may be additionally used in combination with the above substance. However, there is no particular limitation on the solvent as long as the present invention is applicable thereto, and the solvent is not limited to one of those listed above.

Next, the “resistance lowering (reducing) process” according to the present invention will be described.

According to the present invention, in the “resistance lowering process”, an energy beam such as an electron beam, an ion beam, light, or a laser beam is irradiated to a polymer film from the outside (energy-emitting source), whereby carbonization of polymer can be attained. It is particularly preferable that the “resistance lowering process” of the polymer film is performed in an anti-oxidizing atmosphere, for example, in an inert gas atmosphere or in a vacuum.

The above-described aromatic polymer, especially aromatic polyimide has a high thermal decomposition temperature, and it may express high conductivity when heated at a temperature above the thermal decomposition temperature, typically a temperature in the range of 700° C. to 800° C. or more.

However, when heating is performed until resistance lowering is attained in the polymer film as in the present invention, a method of entirely heating the substrate using an oven, a hot plate, or the like may be subject to constraints, from the viewpoint of heat resistance of other members such as a wiring material and a substrate material which constitute the electron-emitting device.

Thus, according to the present invention, as a method of performing a more preferable resistance lowering process, a polymer film is irradiated with an energy beam emitted from an irradiation means such as an electron beam, an ion beam, a laser beam, or condensed light, therefore the resistance of the polymer film (resistivity of the polymer) is reduced (lowered). In this way, the resistance (resistivity) of the polymer film can be lowered while heat influence on the other members is suppressed.

In many cases, however, resistance lowering cannot be efficiently attained with the polymer film material itself. Thus, in the present invention, in order to assist (expedite) carbonization of polymer, a substance expediting thermal decomposition is added into the polymer film to efficiently perform carbonization of the polymer film with the energy beam irradiated from the outside. Further, in the present invention, particularly in the case where light is used in the “resistance lowering process”, a light absorber as the substance expediting thermal decomposition is added to the polymer film; a layer containing a substance with a characteristic of light absorption (a light absorber) is arranged in the vicinity of the polymer film; or a substrate itself is imparted with characteristics of light absorption, whereby carbonization of the polymer film is efficiently performed.

In the present invention, as the substance expediting thermal decomposition, there can be used one containing metal selected from the group consisting of Pt, Pd, Ru, Cr, Ni, Co, Ag, In, Cu, Fe, Zn, Sn, and the like. Particularly, it is preferable to use one containing a metal selected from the group consisting of Pt, Pd, Cr, Ni, and Co. By using the above material, a temperature required for carbonization (resistance lowering process) of the polymer film with the energy beam can be lowered remarkably, and thus, a method of heating the entire substrate can be adopted.

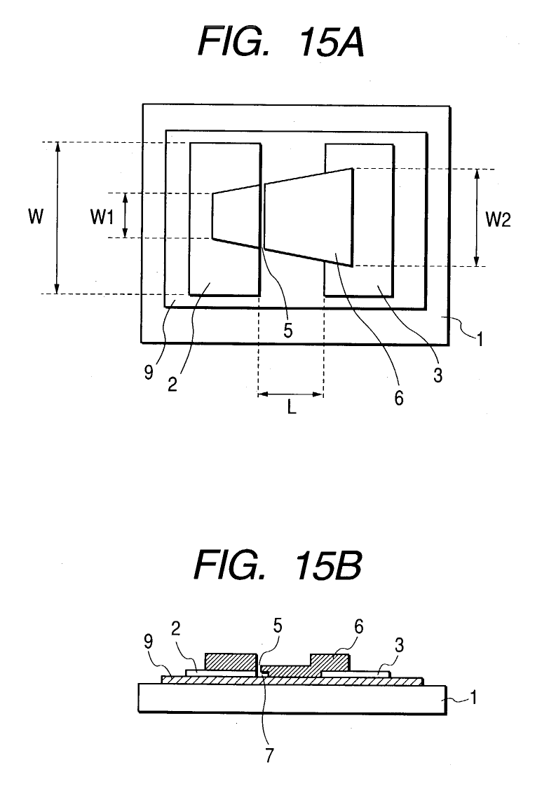

Note that, in the case where the substance expediting thermal decomposition containing metal selected from the group consisting of Pt, Pd, Ru, Cr, Ni, Co, Ag, In, Cu, Fe, Zn, Sn, and the like is used, as to the substance expediting thermal decomposition mixed (added) into the polymer film, the metal atoms are preferably contained at 1×10⁻⁴ mol/cm³ or more with respect to a polymer film of 1 cm³. In terms of weight, the metal atoms are preferably contained at 20 mg/cm³ or more with respect to the polymer film of 1 cm³. As to the upper limit, the metal atoms are preferably set to 3.0×10⁻² mol/cm³ or less with respect to the polymer film of 1 cm³, and are preferably set to 6.0 g/cm³ with respect to the polymer film of 1 cm³ in terms of weight in order to stably form a structure as in FIGS. 15A and 15B in which the gap 5 is arranged in the vicinity of one of the electrodes, and a part of a surface of the electrode 2 is exposed in the gap 5 although the structure is described below.

Next, description will be made of an example of the “resistance lowering process” in the case of using an electron beam in the “resistance lowering process” in the present invention.

First, the substrate 1 on which the electrodes 2 and 3 and the polymer film 6′ including the substance expediting thermal decomposition are formed (refer to FIG. 3B) is set under a reduced pressure atmosphere (in a vacuum container) in which an electron gun is mounted. FIG. 49 is a diagram schematically showing an apparatus used in irradiation of the polymer film 6′ with the electron beam. In FIG. 49, reference numeral 41 denotes an electron-emitting means. The substrate 1 and the electron-emitting means 41 are preferably arranged in the same vacuum container. However, if necessary, the electron-emitting means 41 may be arranged in a vacuum container (not shown) different from the vacuum container in which the substrate 1 is arranged, and differential pumping may be conducted therewith.

A thermionic cathode, for example, can be used as an electron beam source in the electron-emitting means 41. In the case where the electron beam emitted from the electron-emitting means 41 is scanned with accuracy, electron beam converging/deflecting functions 43 and 44 that utilize an electric field/magnetic field can be additionally provided. Further, an electron beam interrupting means 42 is provided in order to finely control a region irradiated with an electron beam.

Electron beam irradiation is preferably performed to the polymer film 6′ in a pulse manner (intermittent manner), but may be performed thereto in a DC manner. Further, wirings 62 and 63 on the substrate 1 are connected to a driver (not shown) so as to apply a voltage to each electrode pair (2, 3).

The condition of the electron beam irradiation can be appropriately selected in a range of, for example, an acceleration voltage Vac=0.5 to 10 kV and a current density ρ=0.01 to 1 mA/mm2.

Next, description will be made of an example using an ion beam in the “resistance lowering process” in the present invention.

First, the substrate 1 on which the electrodes 2 and 3 and the polymer film 6′ including the substance expediting thermal decomposition are formed (refer to FIG. 3B) is set under a reduced pressure atmosphere (in a vacuum container) in which an ion beam-emitting means 21 is mounted. FIG. 50 is a diagram schematically showing an example of an apparatus used in irradiation of the ion beam to the polymer film 6′ mixed (added) with the substance expediting thermal decomposition. In FIG. 50, reference numeral 21 denotes the ion beam-emitting means.

The ion beam-emitting means 21 has an ion source of electron impact type or the like, and is flown with inert gases (desirably Ar) at 1×10⁻² Pa or less. In the case where the ion beam is scanned accurately, ion beam converging/deflecting functions 23 and 24 that utilize an electric field/magnetic field can be additionally provided. Further, there is a case where an ion beam interrupting means 22 is provided in order to finely control a region irradiated with an ion beam.

The ion beam is preferably irradiated to the polymer film 6′ in a pulse manner, but may be irradiated thereto in a DC manner. Further, the wirings 62 and 63 on the substrate 1 are connected to a driver (not shown) so as to apply a voltage to each pair of electrodes 2 and 3. The condition of the ion beam irradiation can be appropriately selected in a range of, for example, an acceleration voltage Vac=0.5 to 10 kV and a current density ρ=0.5 to 10 μA/mm².

Further, in the case of using light in the “resistance lowering process” in the present invention, a substance with a characteristic of light absorption (i.e., a light absorber) can be used as the substance expediting thermal decomposition. Hereinafter, description will be made of the light absorber. The case where light is used in the resistance lowering process corresponds to not only the case where the light absorber is mixed into a polymer film but also the case where a light absorber layer is arranged between the polymer film and the substrate 1 and the case where the light absorber layer is arranged on the surface of the polymer film.

The thickness of the polymer film 6′ used in the present invention is substantially 10 nm to 100 nm, preferably several tens of nm although depending on the resistance value set for the “resistance lowering process” described below. The absorbance of the film is generally expressed as follows in accordance with Lambert-Beer law:

I=I₀10^{-εl}

(where I represents intensity of transmitted light, I₀ represents intensity of incident light, ε represents absorption coefficient, and l represents thickness). In the case where the film thickness is thin, a sufficient absorbance cannot be obtained in some cases.

The substance with the characteristic of light absorption (i.e., the light absorber) according to the present invention-is one for efficiently absorbing light with the irradiated wavelength and transmitting an energy of the light to polymer. For this reason, the light absorber (which has a characteristic of light absorption) refers to a substance whose rate of light absorption is higher than a light absorption rate of a polymer composing the polymer film in bulk. And, in the case that the light absorber is used in a state of particles, the “light absorber” is defined as a substance which has a higher light absorption rate than a light absorption rate of a polymer whose particle size (volume) is equal to a size of one particle of that substance. The light absorber according to the present invention converts the absorbed light into thermal energy to expedite carbonization of a polymer film. As the light absorber, for example, a dye such as an azo dye or an anthraquinone dye can be adopted. In the case where the above dye is used as the light absorber, the dye is previously dissolved into a precursor solution of an organic polymer film, and then, the organic polymer film containing the light absorber can be formed on the substrate by a method such as an inkjet method. On the other hand, an organic pigment, graphite, an inorganic pigment such as a conductive carbon, further, particles made of metal oxide, or the like can be adopted as the light absorber. In the case where the above pigment or the like is adopted as the light absorber, the pigment or the like is applied to the entire surface by a spray coating method etc. to be used as it is. Alternatively, if necessary, it is possible that patterning is performed using photoresist simultaneously with the entire surface application of the organic polymer film (or precursor thereof) through a spin coating method or the like to thereby form the light absorber and the polymer film at desired positions on the substrate.

As the light to be irradiated for resistance lowering of the polymer film, preferably used is laser whose beam diameter can be narrowed and whose wavelength range is narrow. Various wavelengths of the laser can be used. However, it is preferable that an absorption band of the light absorber and the wavelength of the laser are set to be matched in advance in order that the light absorber to be used efficiently absorbs light energy and converts it into thermal energy.

Further, in the laser irradiation, irradiation power preferably has an appropriate value not more than about 20 W in order to carbonize only the polymer film 6′ and not to impart damage to the other members. However, since output energy of the laser beam can be controlled with pulse modulation, it can be said that limitation is not placed on the irradiation power if an irradiation pulse is shortened with the use of a high-output laser while lengthened in the case of using a low-output laser.

The light emitted from a light source such as a xenon lamp or a halogen lamp can be selected as the light to be irradiated. The above light generally has a wide beam diameter differently from the laser, and thus, can be irradiated to a wider area at a time. Incidentally, the light emitted from the above light source has a wide wavelength range. For example, xenon light has a wavelength range of 350 to 1100 nm, and halogen light has a wavelength range of 300 nm to 5000 nm. In the case of irradiation of the light having a wide wavelength range as described above, the number of choices of the light absorber used in the present invention increases; on the other hand, attention needs to be paid because the temperature of other member excessively rises due to absorption of the light with the above wavelength. It is known that a temperature does not so rise at the portion transmitted with light or the portion having a high reflectivity in the case of using any of the laser, the xenon light, and the halogen light.

In the methods of manufacturing an electron-emitting device, an electron source, and an image-forming apparatus according to the present invention, the laser, the xenon light, or the halogen light can be appropriately used depending on the used member.

Next, description will be made of a specific example of the method of manufacturing an electron-emitting device using a substance expediting thermal decomposition according to the present invention, taking as an example the electron-emitting device in the embodiment mode shown in FIGS. 1A and 1B with reference to FIGS. 3A to 3D.

(1) A base plate (substrate) 1 made of glass or the like is sufficiently washed using a detergent, pure water, an organic solvent, and the like. An electrode material is deposited on the substrate 1 by a vacuum deposition method, a sputtering method, or the like. Thereafter, electrodes 2 and 3 are formed on the substrate 1 using, for example, a photolithography technique (FIG. 3A). Here, Pt, for example, can be used as the electrode material.

(2) The substrate 1 provided with the electrodes 2 and 3 is prepared. Then, a polymer film 6′ including a substance expediting thermal decomposition is formed so as to connect between the electrodes 2 and 3 (FIG. 3B). The polymer film 6′ can be formed by applying, for example, a polymer precursor solution mixed with the substance expediting thermal decomposition onto the substrate 1 and conducting drying (removal of the solvent)/curing thereto. There is a case where the resultant polymer precursor solution obtained by being applied and dried on the substrate corresponds to the polymer film depending on the material that constitutes the polymer precursor.

Aromatic polyimide is preferable as the polymer that constitutes the polymer film 6′. Therefore, a polyamic acid solution can be used as the polymer precursor solution. Note that, in the case where polyimide is used as the polymer for the polymer film 6′ and the substance expediting thermal decomposition to be mixed with the polymer film 6′ is mixed into the polymer precursor solution, the substance expediting thermal decomposition being in the state of a complex or the like, it is preferable that polyamic acid ester is used as the polymer precursor. Gelation of the precursor solution can be suppressed by using polyamic acid ester.

In a method of forming the polymer film 6′ containing the substance expediting thermal decomposition 8, various known methods, namely, a spin coating method, a printing method, a dipping method, and the like can be used in the case of using a polymer solution or polymer precursor solution. Particularly, the printing method is preferable since the polymer film 6′ can be formed into a desirable shape without using a patterning means in accordance with the method. Above all, an inkjet printing method enables direct formation of a pattern of several hundreds of μm or less, and thus is effective for manufacturing of an electron source in which electron-emitting devices are arranged at high density, which is as applied to a flat display panel.

The polymer film 6′ containing the substance expediting thermal decomposition can be formed on the substrate in accordance with the above-described method using the solution obtained by mixing the substance expediting thermal decomposition into the polymer precursor solution or polymer solution. Further, in the case where metal is used as the substance expediting thermal decomposition, it is preferable to use a method of forming a polymer film on the substrate 1 and then making a substance expediting thermal decomposition absorbed to the polymer film. As a method of making the substance expediting thermal decomposition absorbed to the polymer film, there can be used, for example, a method of applying/drying a polymer solution or polymer precursor solution on a substrate and then applying thereto a solution containing a complex of the above metal constituting the substance expediting thermal decomposition (solution containing metal ions constituting the substance expediting thermal decomposition). The above metal complex solution (solution containing metal ions) is applied onto the resultant obtained by drying the polymer solution or polymer precursor solution (which corresponds to the polymer film in some cases), whereby the above metal can be made to soak into the resultant obtained by drying the polymer solution or polymer precursor solution. Further, a method of exposing the polymer film (or a film obtained by drying the precursor solution of the polymer or drying the solution of the polymer) to a vapor of the metal described above can also be used as one of a method for soaking (penetrating) the substance expediting thermal decomposition into the polymer film. The polymer film (or a film obtained by drying the precursor solution of the polymer or drying the solution of the polymer) in the vapor of the metal is preferably baked, since the metal is effectively absorbed (penetrated or soaked) into the polymer film.

(3) Next, a “resistance lowering process” for reducing (lowering) the resistivity (resistance) the polymer film 6′ containing the substance expediting thermal decomposition 8 is performed. The “resistance lowering process” is a process of making the polymer film 6′ express conductivity and changing the polymer film 6′ into a conductive film 6 (film obtained by reducing (lowering) resistance of the polymer film 6′). This “resistance lowering process” can be performed by irradiating the polymer film 6′ containing the substance expediting thermal decomposition with an energy beam such as an electron beam, a laser or ion beam, or light. It is particularly preferable that the energy beam irradiation is performed in a non-oxidative atmosphere such as an inert gas atmosphere or vacuum. In this step, from the viewpoint of the step of forming a gap 5 described below, the resistance lowering (reducing) process is continued until the polymer film 6′ is converted into the electroconductive film 6 (film obtained by reducing a resistance (resistivity) of the polymer film) with the sheet resistance with in a range between 10³ Ω/□ or more and 10⁷ Ω/□ or less. The energy beam irradiation can be completed at the time when a desired resistance value is obtained by monitoring the resistance value between the electrodes 2 and 3, for example. However, experience shows that the resistance value does not necessarily need to be measured if an irradiation time is known.

In the case where light irradiation is performed in the “resistance lowering process”, as shown in FIG. 3C, the polymer film 6′ containing the substance expediting thermal decomposition (light absorber) 8 is irradiated with light such as laser or xenon light (halogen light) from irradiation means 10 to attain resistance lowering in the polymer film 6′. More specifically, the substrate 1 on which the electrodes 2 and 3 and the polymer film 6′ containing the light absorber 8 are formed is placed on a stage in a non-oxidative atmosphere such as inert gases or a vacuum, and then is irradiated with the light.

For example, a pulse semiconductor laser (with a wavelength of 810 nm, for example) can be used as a laser source. In this case, a material having an absorption band in the vicinity of 810 nm is used as the light absorber 8. The laser irradiation time is appropriately selected depending on an irradiation diameter, a laser output, a pulse width, and an irradiation duty.

Further, the energy beam irradiation is not necessarily performed over the entire polymer film 6′ containing the substance expediting thermal decomposition 8, but is preferably performed over the entire polymer film 6′.

Also, the “resistance lowering process” can be performed by baking the polymer film 6 containing the substance expediting thermal decomposition in a vacuum or an inert gas atmosphere.

Further, when the method of baking the polymer film in a vapor of the metal in order to make the polymer film absorb the metal is used, the “resistance lowering process” and the absorbing process of making the polymer film absorb the metal can be performed at the same time.

Also, since the polymer film 6 contains the substance expediting thermal decomposition, resistance lowering can be performed at a lower temperature compared with the case where the polymer film 6 does not contain the substance expediting thermal decomposition. As a result, the resistance lowering process can be conducted even in the case of using a glass substrate with a low strain point, which leads to reduction in costs.

(4) Next, a “voltage applying process” for conducting formation of a gap 5 is' performed to the film 6 obtained through the “resistance lowering process” (FIG. 3D). The formation of the gap 5 can be conducted by applying a voltage (making a current flow) between the electrodes 2 and 3, for example. Note that a pulse voltage can be used as the voltage to be applied. The gap 5 is formed in a part of the film 6 obtained by reducing resistance of the polymer film containing the substance expediting thermal decomposition.

This voltage applying process can be also performed by continuously applying voltage pulses between the electrodes 2 and 3 while the above-described resistance lowering process is performed simultaneously. In any case, the voltage applying process is desirably conducted in a reduced pressure atmosphere, preferably in an atmosphere with a pressure of 1.3×10³ Pa or less.

In the voltage applying process, a current corresponding to the resistance value of the conductive film 6 (film obtained by reducing resistance of the polymer film containing the substance expediting thermal decomposition) flows. Therefore, in the state in which the resistance of the conductive film 6 is extremely low, that is, in the state in which resistance lowering has excessively progressed, large quantity of power is required for the formation of the gap 5. The formation of the gap 5 with relatively small energy can be performed by adjusting a degree of progress in resistance lowering. Therefore, it is most preferable that the resistance lowering process with energy irradiation is uniformly performed over the entire region of the polymer film 6′. However, the resistance lowering process may also be performed to only a part of the polymer film 6′.

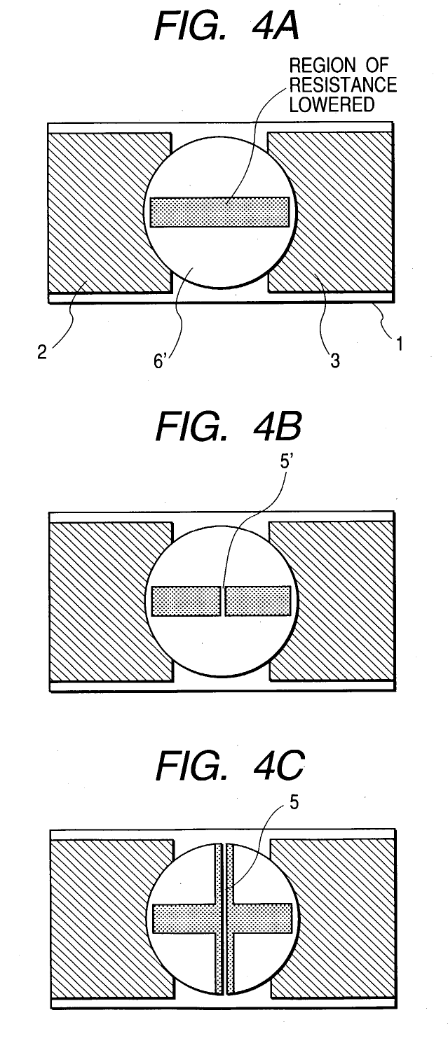

FIGS. 4A to 4C are schematic diagrams (plan views) showing a forming process of the gap 5 in the case where a part of the polymer film 6′ containing the substance expediting thermal decomposition 8 is subjected to resistance lowering in a direction parallel to the substrate surface. FIG. 4A corresponds to the state before the voltage applying step, FIG. 4B corresponds to the state immediately after the start of the voltage applying step, and FIG. 4C corresponds to the state at the time of completion of the voltage applying step.

First, a current is made to flow to a region of the polymer film 6′ in which resistance is lowered, thereby forming a narrow gap 5′ that is the starting point of the gap 5 (FIG. 4B). In the process in which electrons tunnel through the formed narrow gap 5′ to scatter to be emitted, the region where carbonization has not developed yet is gradually carbonized, and finally, the gap 5 is formed over the entire polymer film 6′ in the direction substantially parallel to the substrate surface (FIG. 4C).

In case of using catalytic metals such as Pt for electrodes 2 and 3, through the resistivity (resistance) reduction process and/or the voltage applying process, the thickness of the processed polymer film positioned on the electrodes becomes thinner than that of the processed polymer film positioned between the electrodes.

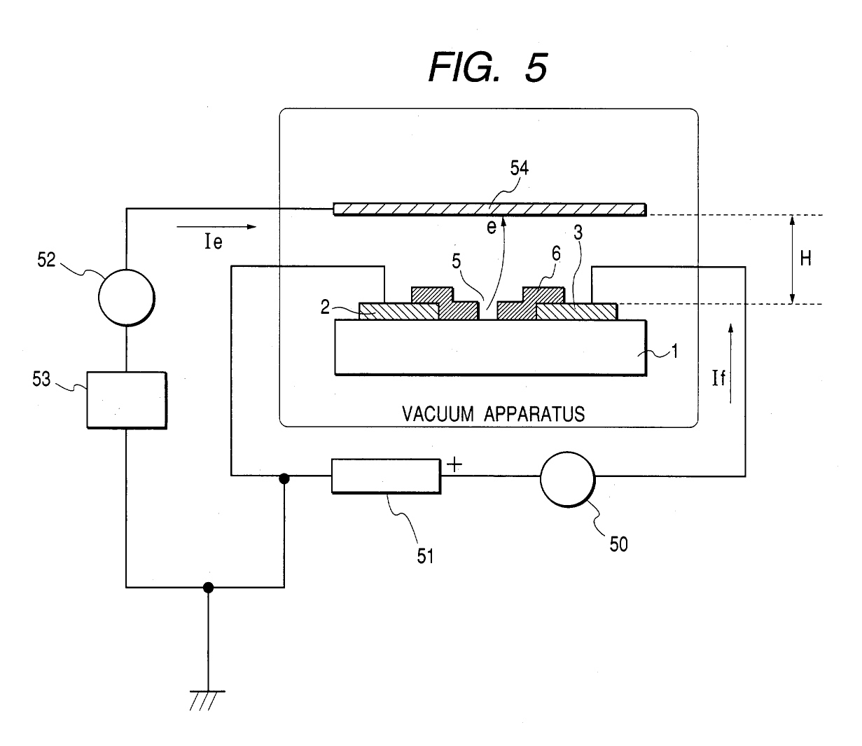

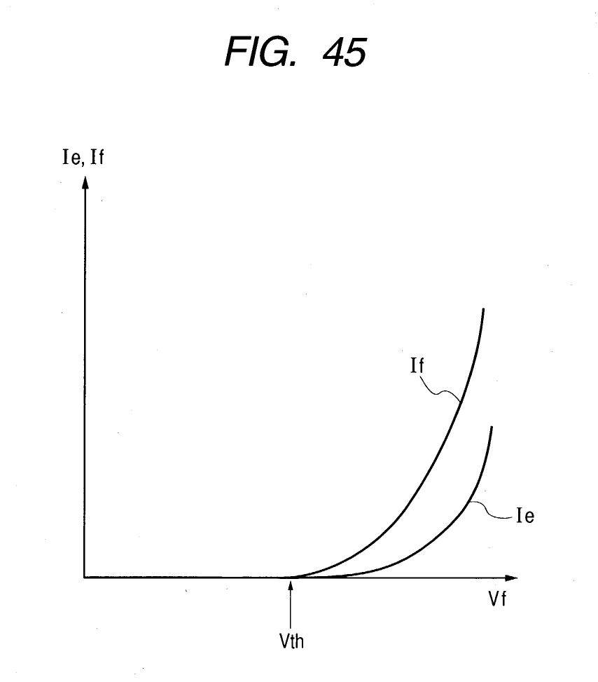

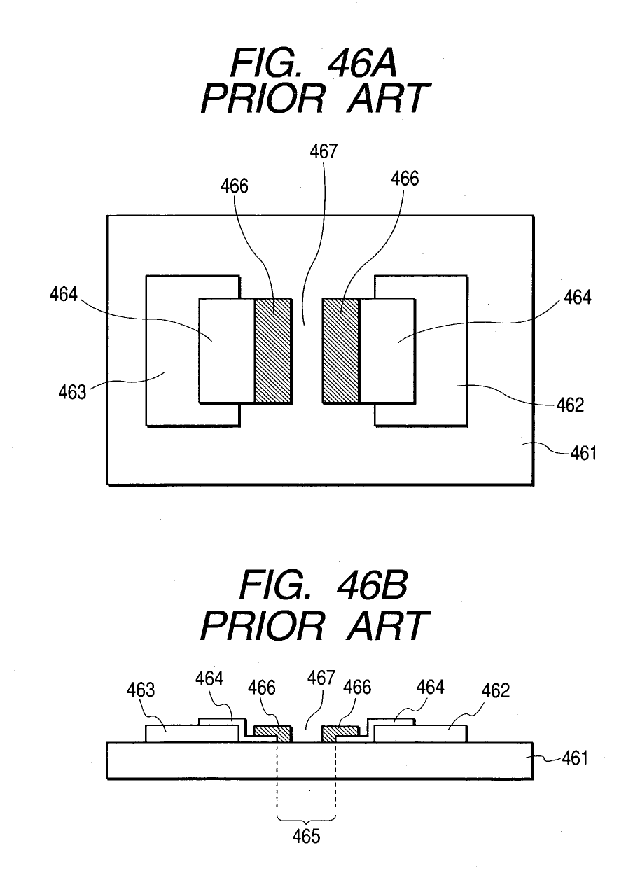

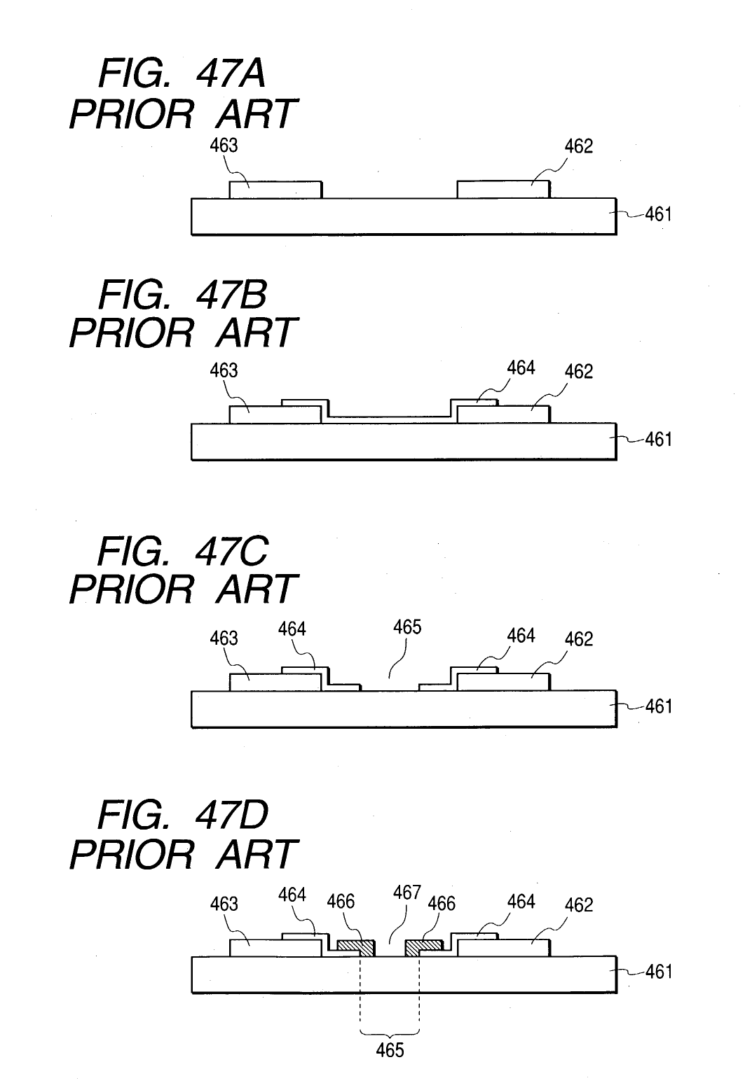

The voltage-current characteristics of the electron-emitting device obtained through the above steps were measured with a measurement apparatus shown in FIG. 5. As a result, the characteristics shown in FIG. 45 were obtained.

In FIG. 5, the members denoted by the same reference numerals as those used in FIGS. 1A and 1B and the like indicate the same members in FIGS. 1A and 1B and the like. Reference numeral 54 denotes an anode, 53 denotes a high voltage power source, 52 denotes an ammeter for measuring an emission current Ie emitted from an electron-emitting device, 51 denotes a power source for applying a driving voltage Vf to an electron-emitting device, and 50 denotes an ammeter for measuring a device current that flows between the electrodes 2 and 3.

The electron-emitting device has a threshold voltage Vth as shown in FIG. 45. Thus, if a voltage lower than the threshold voltage Vth is applied between the electrodes 2 and 3, electrons are not emitted substantially. However, by applying a voltage higher than the threshold voltage Vth, a device current (If) that flows between the electrodes 2 and 3 begins to develop. With the above characteristics, it is possible that an electron source in which a plurality of the above-described electron-emitting devices are arranged in matrix on the same substrate is structured to perform simple matrix drive in which a desired device is selected to be driven.

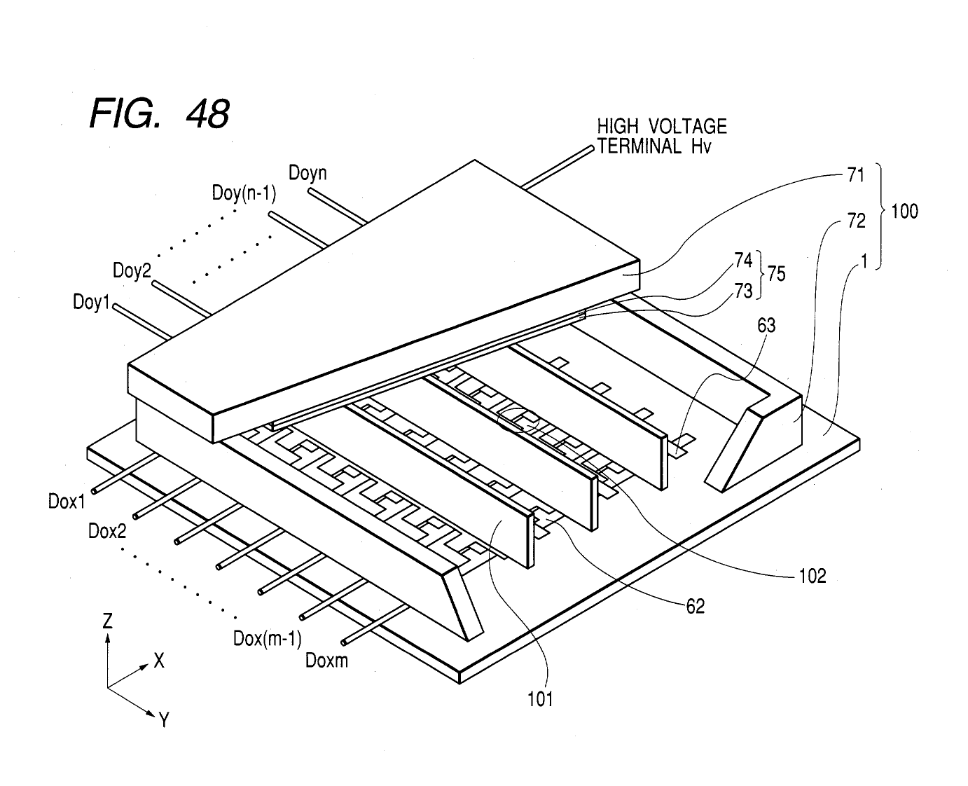

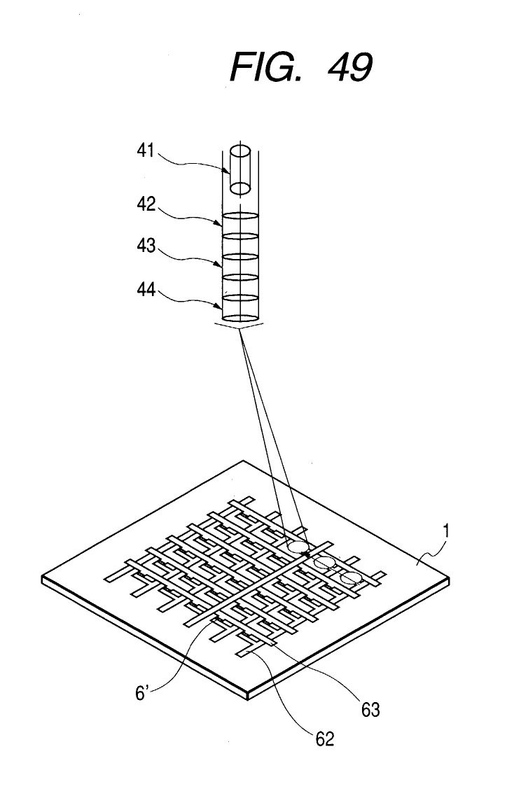

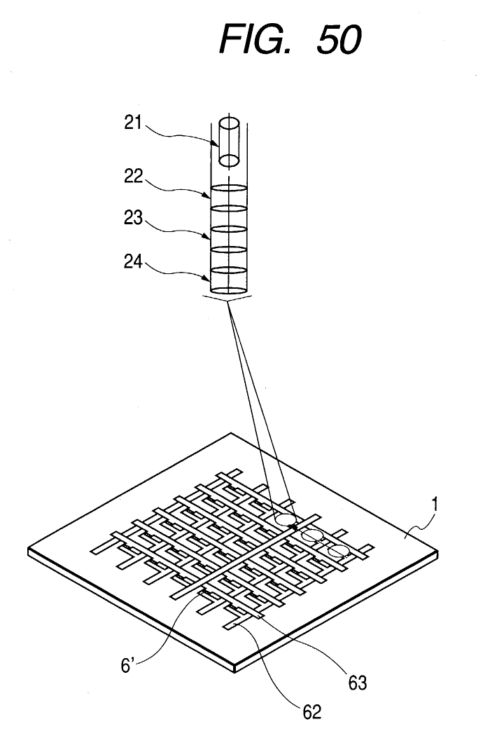

FIG. 48 is a schematic diagram showing an example of an image-forming apparatus using an electron-emitting device 102 manufactured in accordance with the manufacturing method of the present invention. Note that FIG. 48 is a diagram in which parts of a supporting frame 72 and a face plate 71, which are described below, are removed in order to explain the inside of the image-forming apparatus (airtight container 100).

In FIG. 48, reference numeral 1 denotes a rear plate on which a large number of electron-emitting devices 102 are arranged. Reference numeral 71 denotes the face plate provided with an image-forming member 75. Reference numeral 72 denotes the supporting frame for keeping the space between the face plate 71 and the rear plate 1 in a reduced pressure state. Reference numeral 101 denotes a spacer arranged for keeping an interval between the face plate 71 and the rear plate 1.

In the case where the image forming apparatus 100 is a display, the image-forming member 75 is constituted by a phosphor film 74 and a conductive film 73 such as a metal back. Reference numerals 62 and 63 denote wirings respectively connected to the electron-emitting devices 102 for applying a voltage thereto. Doy1 to Doyn and Dox1 to Doxm denote drawing wirings for connecting a driver circuit or the like arranged outside of the image-forming apparatus 100 with end portions of the wirings 62 and 63 led to the outside from the reduced pressure space (space surrounded by the face plate, the rear plate, and the supporting frame) of the image-forming apparatus.

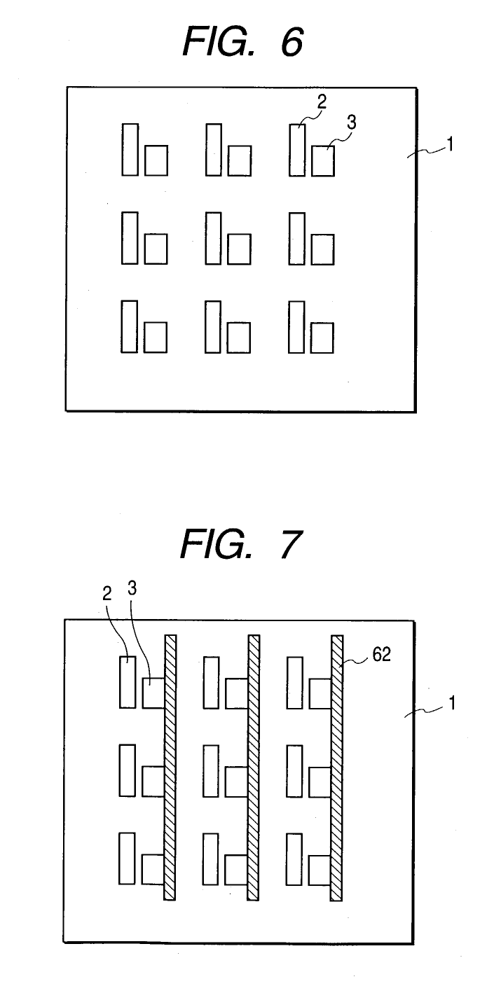

Next, examples of methods of manufacturing an electron source (rear plate on which a large number of electron-emitting devices 102 are arranged) and an image-forming apparatus shown in FIG. 48 according to the present invention using the above-described electron-emitting device are described below with reference to FIGS. 6 to 12 and the like.

(A1) At first, a rear plate 1 that constitutes the electron source is prepared. The rear plate 1 made of an insulating material is used, and particularly, the rear plate 1 made of glass is preferably used.

(B1) Next, a plurality of pairs of electrodes 2 and 3 shown in FIGS. 1A and 1B are formed on the rear plate 1 (FIG. 6). An electrode material may be a conductive material, but it is preferable to use a material which does not receive damage due to energy irradiation or baking in a “resistance lowering process”. The electrodes 2 and 3 can be formed by one of various methods such as a sputtering method, a CVD method, and a printing method. Note that, in FIG. 6, for simplifying the explanation, there is shown an example in which nine pairs of electrodes in total, i.e., three pairs of electrodes in an X direction and three pairs of electrodes in a Y direction, are formed. However, the number of the pairs of electrodes is appropriately defined depending on the resolution of the image-forming apparatus.

(C1) Subsequently, a lower wiring 62 is formed so as to cover a part of the electrode 3 (FIG. 7). Various methods can be employed for a method of forming the lower wiring 62. Preferably, a printing method is employed. Among printing methods, a screen printing method is preferable in the point that a large-area substrate can be formed at low cost.

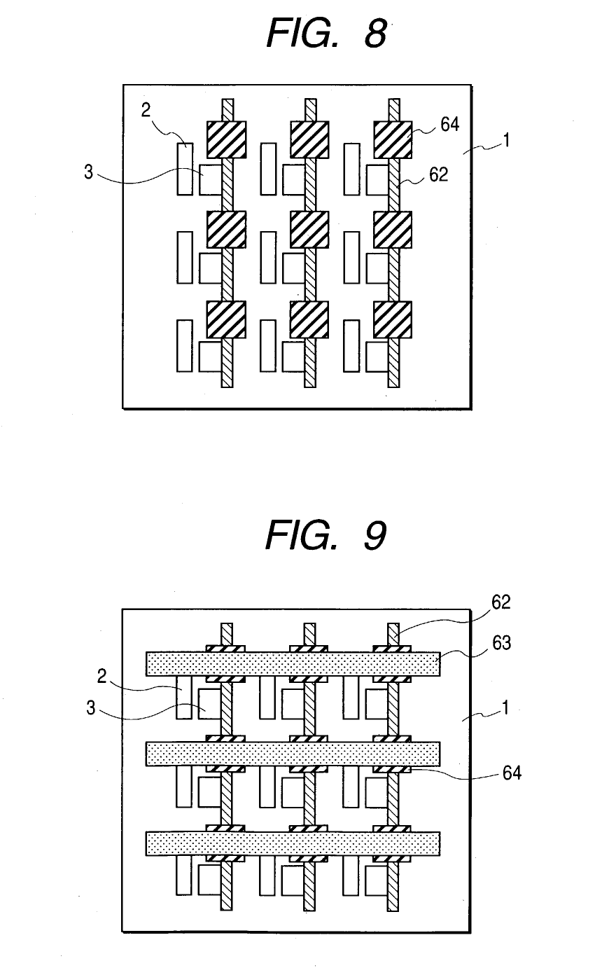

(D1) An insulating layer 64 is formed at an intersecting portion of the lower wiring 62 and an upper wiring 63 to be formed in the next step (FIG. 8). Various methods can also be employed for a method of forming the insulating layer 64. Preferably, a printing method is employed. Among printing methods, a screen printing method is preferable in the point that a large-area substrate can be formed at low cost.

(E1) The upper wiring 63 substantially orthogonal to the lower wiring 62 is formed (FIG. 9). Various methods can also be employed for a method of forming the upper wiring 63. Preferably, a printing method is employed similarly to the lower wiring 62. Among printing methods, a screen printing method is preferable in the point that a large-area substrate can be formed at low cost.

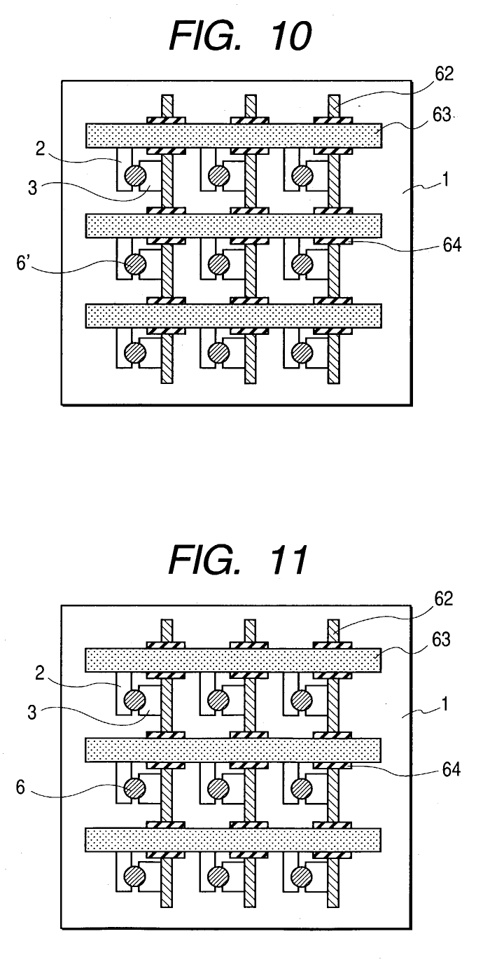

(F1) Next, a polymer film 6′ containing a substance expediting thermal decomposition 8 is formed to connect between the pair of electrodes 2 and 3 (FIG. 10). The polymer film 6′ containing the substance expediting thermal decomposition 8 can be formed by various methods as described above. However, in order to simply form the polymer film 6′ in a large area, a liquid containing a precursor solution of a polymer film or polymer film solution and a substance expediting thermal decomposition (in the state of a complex or particle) is preferably applied by an inkjet method. Note that, in the case where polyimide is used for the polymer film, it is preferable that a precursor solution of polyimide is applied as described above and sequentially baked at 350° C. to be made into an imide form (referred to as “curing process”), thereby obtaining polyimide. However, in the case where there is fear that the substance expediting thermal decomposition is thermally decomposed in the baking step, the curing process is not performed, and the later “resistance lowering step” can take in advance and serve also as the curing process.

(G1) Subsequently, the “resistance lowering process” for reducing the resistance (resistivity) of the polymer film 6′ including the substance expediting thermal decompostion is performed as described above. The “resistance lowering process” to the polymer film 6′ including the substance expediting thermal decomposition is performed by conducting irradiation of an energy beam or baking. The “resistance lowering process” is performed preferably in a reduced pressure atmosphere. Through the step, the polymer film 6′ is imparted with conductivity to be changed into the conductive film 6 (FIG. 11). Specifically, a resistance value of the conductive film 6 falls in a range of 10³ Ω/□ to 10⁷ Ω/□.

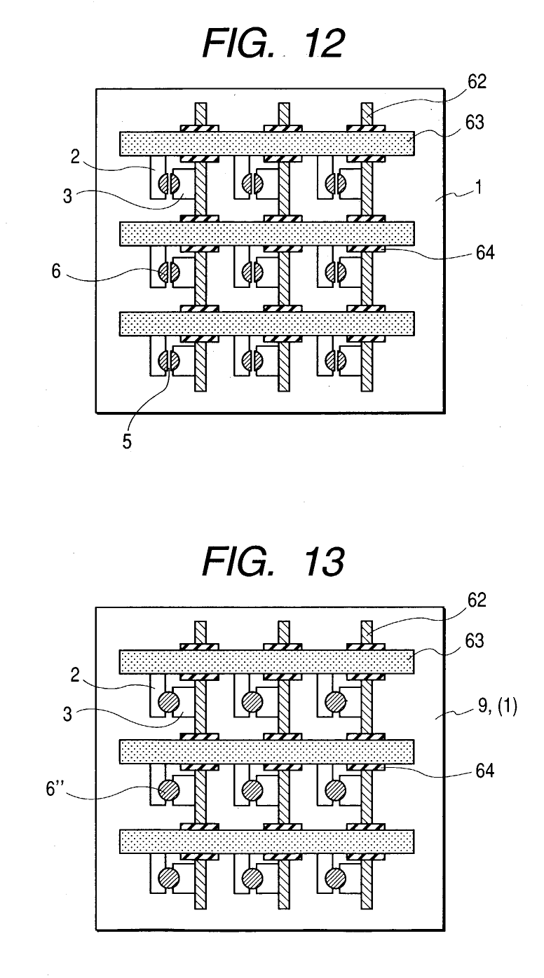

(H1) Next, a gap 5 is formed in the conductive film 6 obtained by the step (G1)(film obtained by reducing the resistance (resistivitly) of the polymer film 6′ including the substance expediting thermal decomposition. The gap 5 can be formed at a time by applying a voltage to the respective wirings 62 and 63. That is, the gap 5 is formed in the conductive film 6 by applying a voltage between the pair of electrodes 2 and 3. Note that the voltage to be applied is preferably a pulse voltage (FIG. 12).

The voltage applying process may also be performed by successively applying voltage pulses between the electrodes 2 and 3 while the above resistance lowering process is simultaneously performed. In any case, the voltage applying process is desirably performed under a reduced pressure atmosphere.

Through the above steps, an electron source provided with a plurality of electron-emitting devices on a substrate can be manufactured.

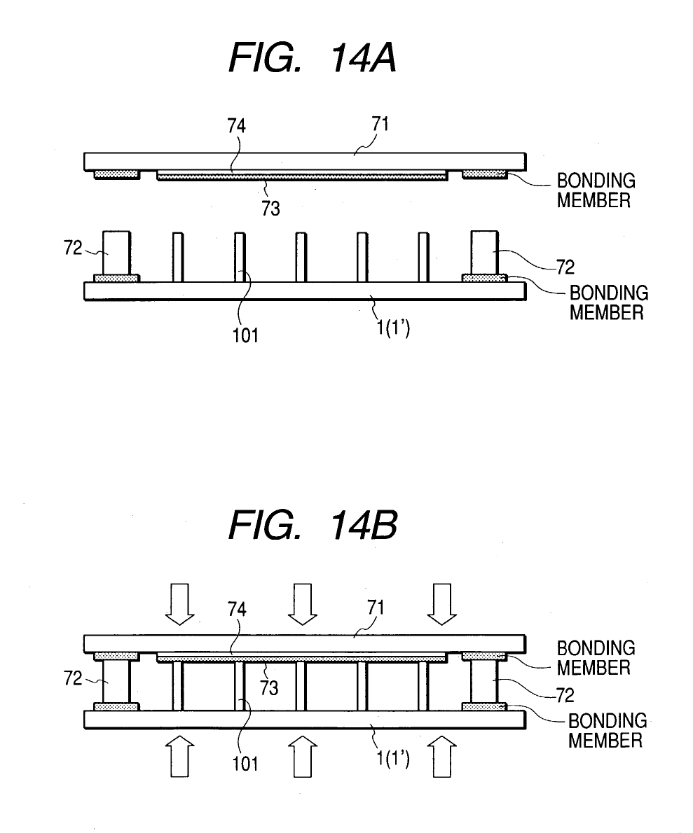

Subsequently, description will be made of a method of manufacturing an image-forming apparatus using the electron source substrate manufactured by the above steps with reference to FIGS. 14A and 14B.

(I) A face plate 71 having an image-forming member composed of a metal back 73 made of an aluminum film and a phosphor film 74 or the like, which is prepared in advance, and the rear plate 1 that has undergone the preceding steps (A1) to (H1) are aligned such that the metal back faces the electron-emitting devices (FIG. 14A). In addition, a bonding member is arranged on a contact surface (contact area) between a supporting frame 72 and the face plate 71. Similarly, another bonding member is arranged on a contact surface (contact area) between the rear plate 1 and the supporting frame 72. The above bonding member to be used is one having the function of retaining vacuum and the function of adherence. Specifically, frit glass, indium, indium alloy, or the like is used for the bonding member.

In FIGS. 14A and 14B, there is shown an example in which the supporting frame 72 is fixed (adhered) by means of the bonding member onto the rear plate 1 that has undergone the preceding steps (A1) to (H1). According to the present invention, however, there is no need to always bond the supporting frame 72 to the rear plate 1 at the time of performing the step (I). In FIGS. 14A and 14B, similarly, there is shown an example in which a spacer 101 is fixed onto the rear plate 1. According to the present invention, however, there is no need to always fix the spacer 101 onto the rear plate 1 at the time of performing the step (I).

Further, in FIGS. 14A and 14B, there is shown an example in which the rear plate 1 is arranged on the lower side while the face plate 71 is arranged on the upper side of the rear plate 1 for the sake of convenience. However, there is no problem as to which one is on the upper side.

Furthermore, in FIGS. 14A and 14B, there is shown an example in which the supporting frame 72 and the spacer 101 are previously fixed (adhered) onto the rear plate 1. However, they may only be mounted on the rear plate or face plate so as to be fixed (adhered) onto the plate in the subsequent “seal-bonding step”.

(J) Next, the seal-bonding step is performed. The face plate 71 and the rear plate 1, which have been arranged to face each other in the above step (I), are pressurized in the direction in which they face each other while at least the bonding member is heated. It is preferable to heat the whole surfaces of the face plate and the rear plate in order to decrease thermal distortion.

In the present invention, the above “seal-bonding step” may be preferably performed in a reduced pressure (vacuum) atmosphere or in a non-oxidative atmosphere. Specifically, the reduced pressure (vacuum) atmosphere is preferably at a pressure of 10⁻⁵ Pa or less, more preferably 10⁻⁶ Pa or less.

This seal-bonding step allows the contact portion between the face plate 71 and the supporting frame 72 and the contact portion between the supporting plate 72 and the rear plate 1 to be airtight. Simultaneously, an airtight container (image-forming apparatus) 100 shown in FIG. 48 and having the inside kept at a high vacuum can be obtained.

Here, the above example is shown in which the “seal-bonding step” is performed in a reduced pressure (vacuum) atmosphere or in a non-oxidative atmosphere. However, the above “seal-bonding step may be performed in the air. In this case, an exhaust tube for exhausting air from a space between the face plate and the rear plate is additionally provided in the airtight container 100. After the “seal-bonding step” is performed, air is exhausted from the inside of the airtight container so as to attain a pressure of 10⁻⁵ Pa or less. Subsequently, the exhaust tube is closed to obtain the airtight container (image-forming apparatus) 100 with the inside being kept at a high vacuum.

If the above “seal-bonding step” is performed in a vacuum, in order to keep the inside of the image-forming apparatus (airtight container) 100 in a high vacuum, it is preferable to provide a step of covering the metal back 73 (surface of the metal back which faces the rear plate 1) with a getter material for exhausting a residual gas between the step (I) and the step (J). The getter material used at this time is preferably an evaporating getter because it simplifies the covering step. Therefore, it is preferable to cover the metal back 73 with barium as the getter film. Furthermore, the step of covering with the getter is performed under a reduced pressure (vacuum) atmosphere as in the case of the above step (J).

Further, in the example of the image-forming apparatus described above, the spacer 101 is arranged between the face plate 71 and the rear plate 1. However, if the size of the image-forming apparatus is small, the spacer 101 is not necessarily required. In addition, when the interval between the rear plate 1 and the face plate 71 is about several hundreds of μm, the rear plate 1 and the face plate 71 can be directly bonded with the bonding member without using the supporting frame 104. In such a case, the bonding member also serves as an alternative material of the supporting frame 72.

In the present invention, furthermore, after the step (step (H1)) of forming the gap 5 of the electron-emitting device 102, the positioning step (step (I)) and the seal-bonding step (step (J)) are performed. However, the step (H1) may also be performed after the seal-bonding step (step (J)).

Next, description will be made of another example of an electron-emitting device manufactured by a manufacturing method according to the present invention.

FIGS. 15A and 15B are diagrams showing another example of the electron-emitting device manufactured by the manufacturing method according to the present invention. Note that FIG. 15A is a plan view, and FIG. 15B is a sectional view on the assumption that the plane is substantially vertical to a surface of a substrate 1 on which electrodes 2 and 3 are arranged while passing therebetween.

In FIGS. 15A and 15B, reference numeral 1 denotes the substrate, 2 and 3 denote the electrodes, 6 denotes a carbon film, 5 denotes a gap, and 9 denotes a layer containing a substance expediting thermal decomposition such as a light absorber (hereinafter referred to as “light absorber layer”). Reference numeral 7 denotes an air gap between the carbon film and the substrate, which constitutes a part of the gap 5.

In this example, description is made of a case where the light absorber layer 9 is arranged below the carbon film 6 between the electrodes 2 and 3. However, the arrangement spot of the light absorber layer 9 is not limited to this, and may be appropriately changed.

In the electron-emitting device in this example, the gap 5 is arranged partially in the vicinity of one of the electrodes (as shown in FIG. 15A, arranged on the W1 side with W1<W2). As shown in FIG. 15B, the surface of the electrode 2 is exposed (exists) at least in a part of the inside of the gap 5.

When the gap 5 is formed in the vicinity of one of the electrodes, electrical conductive characteristics (electron-emitting characteristics) of the electron-emitting device can be made asymmetrical with respect to the polarity of the voltage applied between the electrodes 2 and 3. When comparison is made between the case where a voltage is applied with a certain polarity (forward polarity: the potential of the electrode 2 is made higher than that of the electrode 3) and the case where a voltage is applied with the reverse polarity (reversed polarity), in the case where the applied voltage is set to, for example, 20 V, difference in current value is caused in which a value in one of the above cases becomes ten times as large as that in another case. At this time, voltage-current characteristics of the present invention are of tunnel conduction type in a high electric field.

Further, with the electron-emitting device according to the present invention, an extremely high electron-emission efficiency is obtained. In the measurement of the electron-emission efficiency, an anode electrode is arranged on the device, and drive is performed such that the electrode 2 in the vicinity of the gap 5 has a higher potential compared with the electrode 3. Thus, an extremely high electron-emission efficiency is obtained. When the ratio of a device current If that flows between the electrodes 2 and 3 and an emission current Ie trapped by the anode electrode (Ie/If) is defined as the electron-emission efficiency, the value is as several times as large as that of a conventional surface conduction electron-emitting device. Note that it is preferable that the mode in which the gap 5 is arranged in the vicinity of one of the electrodes is also applied to the mode of FIGS. 1A and 1B in which the layer containing the light absorber is not used.

Although description will be made below in detail, the gap 5 is formed by: arranging a polymer film 6″ to connect between the pair of electrodes 2 and 3; subjecting the polymer film to a resistance lowering process; and performing a “voltage applying step” for applying a voltage (making a current flow) to the film 6 obtained by reducing a resistance of the polymer film. At this time, the connection form of the film 6 obtained by reducing a reistance of the polymer film and the pair of electrodes 2 and 3 is made asymmetrical, whereby the gap 5 can be selectively arranged in the vicinity of an end portion (edge) of one electrode. Such control of the gap position can be similarly realized also in the mode of FIGS. 1A and 1B in which the layer containing the light absorber is not used. That is, the gap position and the structure in which the surface of the electrode 2 is exposed (exists) in the gap 5 do not depend on the presence of the layer containing the light absorber.

The gap position control can be performed such that at the time of forming the gap 5 by the “voltage applying step” Joule heat generated in the vicinity of the end portion (edge) of one electrode is higher than that generated in the vicinity of the end portion (edge) of the other electrode.

Some of the reasons why Joule heat generated in the vicinity of the electrode 2 and Joule heat generated in the vicinity of the electrode 3 can be made asymmetrical in the “voltage applying step” are described as follows.

1) The connection resistance or step coverage between the film 6 obtained through the resistance lowering process and the electrode 2 and the connection resistance or step coverage between the film 6 obtained through the resistance lowering process and the electrode 3 are asymmetrical.

2) A degree of thermal diffusion differs between the vicinity of the region where the film 6 obtained through the resistance lowering process is connected with the electrode 2 and the vicinity of the region where the film 6 obtained through the resistance lowering process is connected with the electrode 3.

3) When the shapes of the electrodes are asymmetrical, disproportion is caused in film thickness distribution at the time of formation of the polymer film 6″ depending on a film deposition method of the polymer film 6″. In such a case, the resistance value has a disproportionate distribution even if the resistance lowering process is performed to the polymer film 6″.

4) When the connection length of the electrode 2 and the film 6 obtained through the resistance lowering process and the connection length of the electrode 3 and the film 6 obtained through the resistance lowering process are asymmetrical, a current density is larger with the connection length shorter at the time of energization.

In the case where the layer including substance expediting thermal decomposition (the light absorber layer) 9 is formed separately from the polymer film as in the mode shown in FIGS. 15A and 15B, the following materials are preferably used for the light absorber.

It is known that, in general, a non-metal material having a semi-infinite size and excellent crystallinity has a forbidden band, and can absorb light peculiar to an individual piece. Further, even a non-metal thin film or amorphous non-metal similarly has a forbidden band in many cases, and can absorb light. In particular, in the case of a semiconductor material, the width of the forbidden band is several tens of meV to several eV, and the wavelength of the light capable of being absorbed can be changed in a range of several hundreds of nm to several μm depending on the material. Thus, the semiconductor material is very useful as the light absorber used in the present invention. For example, in the case of using Si as the light absorber, the light with a wavelength not more than 1000 nm can be absorbed.

Further, the wavelength range of the light capable of being absorbed can be optionally set by using a multi compound semiconductor or a heavily doped semiconductor based on band engineering. For example, in the case of using In_{X}Ga_{(1-X)}As that is a ternary compound, X is changed in a range of 0 to 1, thereby being capable of changing the wavelength range of the light that can be absorbed in a range of not more than 800 nm to not more than 2500 nm.

It is considered an insulator is used as the light absorber besides the semiconductor. Glass mixed with a colorant, green sapphire (Al₂O₃:Fe), or the like can be used.

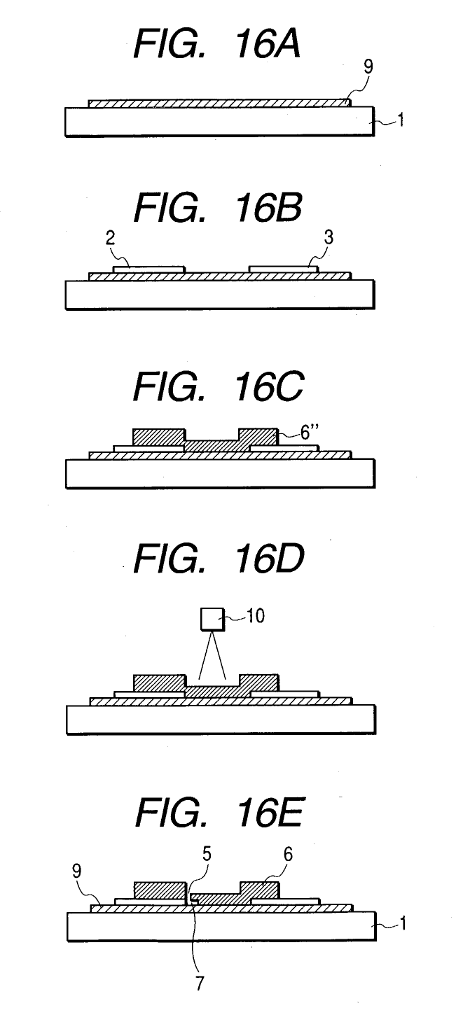

Next, description will be made of an example of a method of manufacturing an electron-emitting device according to the present invention in which the light absorber layer 9 is formed as in the mode shown in FIGS. 15A and 15B with reference to FIGS. 16A to 16E.

(1) A base plate (substrate) 1 made of glass is sufficiently washed with a detergent, pure water, an organic solvent, and the like. Then, a light absorber is deposited by a vacuum evaporation method, a sputtering method, a CVD method, or the like to form the light absorber 9 on the substrate 1. For example, a semiconductor material or the like having a satisfactory absorbance in a visible light region is preferably used as the light absorber. It is more preferable to match the wavelength of the light to be emitted from the light source to an absorbing wavelength of the light absorber, in view of the effective light-heat conversion. Here, amorphous silicon is selected as the light absorber to be deposited (FIG. 16A). The thickness of the light absorber layer 9 is sufficiently made smaller than an electrode interval L, and further, the thickness of the substrate 1 is sufficiently made larger than that of the polymer film 6″ to be formed later, whereby heat generated in the light absorber layer 9 can be efficiently poured into the polymer film.

(2) An electrode material is deposited on the substrate 1 on which the light absorber layer 9 is provided by a vacuum evaporation method, a sputtering method, or the like, and then, electrodes 2 and 3 are formed by using a photolithography technique (FIG. 16B). The interval L between the electrode 2 and the electrode 3 is set to 1 μm to 100 μm. Here, a general conductive material can be used as the material for the electrodes 2 and 3. Preferably, a metal material or a material containing metal as its main constituent is used as the material for the electrodes 2 and 3.

(3) Next, the polymer film 6″ is formed on the substrate 1 on which the electrodes 2 and 3 are provided so as to connect therebetween (FIG. 16C).

A method of forming the polymer film 6″ can employ one of various known methods, that is, a spin coating method, a printing method, a dipping method, and the like, similarly to the above-described method of forming the polymer film 6′ containing the light absorber 8. In particular, the printing method is preferable in the point that the polymer film 6″ can be formed at low cost. By using an inkjet printing method above all, a patterning step can be made unnecessary, and also a pattern with a length of not more than several hundreds of μm can be formed. Thus, this is also effective for manufacturing of an electron source in which electron-emitting devices are arranged at high density, which is as applied to a flat panel display.

In the case of forming the polymer film 6″, the polymer film can be manufactured by applying a solution of a polymer material and drying the solution. However, if necessary, a method of appling a precursor solution of the polymer material and changing the precursor into the polymer through heating or the like can be employed.

Aromatic polymers are preferably used for the polymer material as described above. However, most of the polymers are difficult to be dissolved, and thus, a method of conducting application of a precursor solution of the polymer is effective. For example, a polyimide film can be formed by applying a polyamic acid solution, which is a precursor of aromatic polyimide and conducting heating or the like to the solution.

As shown in FIGS. 15A and 15B, the process is performed such that the connection length of the electrode 2 and the polymer film 6″ (or a film 6 obtained by subjecting a polymer film to resistance lowering) and the connection length of the electrode 3 and the polymer film 6″ (or the film 6 obtained by subjecting a polymer film to resistance lowering) differ from each other depending on the shape of the polymer film 6″ (or the film 6 obtained by subjecting a polymer film to resistance lowering). For example, as shown in FIGS. 15A and 15B, the polymer film 6″ is formed such that the connection length of the polymer film and the electrode 2 (≅W1) and the connection length of the polymer film and the electrode 3 (≅W2) differ from each other.

In order to make difference in the connection length, a method of patterning the polymer film 6″ can be used. Further, in the case of forming the polymer film using an inkjet printing method, a method of applying a droplet of a solution of the polymer or the precursor of the polymer, in a position neighboring to one of the electrodes can be used. Alternatively, after the surface energy of one of the electrodes and the surface energy of the other electrode are made different from each other, a polymer material solution or a precursor solution of a polymer material is applied and heated, thereby being capable of forming the polymer film 6″ with mutually different connection lengths. As described above, various methods can be appropriately selected for a method of obtaining different connection lengths.

(4) Next, a “resistance lowering process” for lowering resistance in the polymer film 6″ is performed. The “resistance lowering process” is a process of making the polymer film 6″ express conductivity and changing the polymer film 6″ into the conductive film 6 (film obtained by subjecting the polymer film 6″ to resistance lowering).

In this step, the resistance lowering process is continued until the sheet resistance of the conductive film 6 (film obtained by reducing a resistance (resistivity) of the polymer film 6′ is lowered (reduced) to fall in a range of 10³ Ω/□ to 10⁷ Ω/□ from the viewpoint of the gap forming step described below.

In the resistance lowering (reducing) process, the polymer film 6″ is irradiated with light such as laser from a laser irradiation means 10 or xenon light (halogen light) irradiation means 10 to attain resistance lowering in the polymer film 6″.

For example, in the case of using the laser, the substrate 1 on which the light absorber 9, the electrodes 2 and 3, and the polymer film 6″ are formed is placed on a stage, and the polymer film 6″ is irradiated with the laser. At this time, as to an environment for laser irradiation, the irradiation is preferably performed in inert gases or in a vacuum in order to suppress oxidization (burning) of the polymer film 6″. However, the irradiation can be performed in the air depending on the laser irradiation condition.

As to the laser irradiation condition at this time, the irradiation is preferably performed by using, for example, a second harmonic (wavelength of 532 nm) of a pulse YAG laser. Further, during the laser irradiation, the resistance value between the electrodes 2 and 3 may be monitored to make a judgement on completion of the laser irradiation at the time when a desired resistance value is obtained.

Note that it is preferable that a material having a higher light absorption characteristic with respect to the laser to be irradiated is selected for the material that constitutes the polymer film 6″ compared with the material that constitutes the electrodes 2 and 3, whereby only the polymer film 6″ is substantially heated.

The above-described “resistance lowering process” does not necessarily need to be performed over the entire polymer film 6″. However, when it is considered that the electron-emitting device of the present invention is driven in a vacuum atmosphere, it is not preferable that an insulator is exposed to the vacuum atmosphere. Therefore, it is preferable that the “resistance lowering process” is substantially performed to the entire polymer film 6″.

Further, the conductive film 6 formed by the “resistance lowering process” is also called a “conductive film containing carbon as its main constituent” or simply a “carbon film”, as described above.

(5) Next, formation of a gap 5 is performed to the conductive film 6 obtained through the step (4) (FIG. 16E). For example, the formation of the gap 5 can be conducted by applying a voltage (making a current to flow) between the electrodes 2 and 3. Note that a pulse voltage is preferable as the voltage to be applied. Through this voltage applying step, the gap 5 is formed in a part of the conductive film 6 (film obtained by subjecting the polymer film 6″ to resistance lowering). The voltage applied at this time may be a DC or AC voltage or a pulse voltage with a rectangular shape or the like. However, the pulse voltage is preferably used as the voltage applied in the voltage applying step in driving the electron-emitting device at a low voltage.

The voltage applying step may also be performed by continuously applying voltage pulses between the electrodes 2 and 3 while the above-described resistance lowering process is performed simultaneously, that is, during light irradiation. Further, in order to form the gap 5 with excellent reproducibility, a method of applying a pulse voltage which increases with time to the electrodes 2 and 3 is preferable.

Note that the conductive film 6 obtained through the “resistance lowering process” is further lowered in resistance in the voltage applying step in some cases. Therefore, there is a case where slight difference is caused in the electrical characteristic or film quality between the conductive film 6 obtained through the “resistance lowering process” and the conductive film 6 with the gap 5 which is obtained through the voltage applying step. However, when there is no particular difference in superiority in terms of crystallinity of carbon between the film obtained by performing the “resistance lowering (reducing) process” on the polymer film and a film obtained by applying a “voltage application step” to the film obtained by the “resistance reducing process”, although details thereof are described below, the following is specified. That is, in this case, the term “carbon film (conductive film) 6 having a gap” and the term “film 6 obtained by performing the resistance reducing process on the polymer film” are used not for classifying films in terms of film quality but for classifying process stages.

The voltage-current characteristics of the electron-emitting device obtained through the above steps were measured with a measurement apparatus shown in FIG. 44. As a result, the typical driving voltage Vf-device current If, driving voltage Vf-emission current Ie characteristics shown in FIG. 45 were obtained.

In FIG. 44, the members denoted by the same reference numerals as those used in FIGS. 15A and 15B and the like indicate the same members in FIGS. 15A and 15B and the like. Reference numeral 84 denotes an anode, 83 denotes a high voltage power source, 82 denotes an ammeter for measuring the emission current Ie emitted from an electron-emitting device, 81 denotes a power source for applying a driving voltage Vf to an electron-emitting device, and 80 denotes an ammeter for measuring the device current If that flows between the electrodes 2 and 3.

In the measurement of the device current If and the emission current Ie of the electron-emitting device, the ammeter 80 and the power source 81 are connected to the electrodes 2 and 3, and the anode electrode 84 connected to the ammeter 82 and to the power source 83 is arranged above the electron-emitting device. Further, the electron-emitting device and the anode electrode 84 are arranged in a vacuum apparatus, and the vacuum apparatus is equipped with devices necessary for the vacuum apparatus, such as an exhaust pump and a vacuum gauge, which are not shown in the figure. Measurement evaluation of the electron-emitting device can be performed in a desired vacuum. Note that a distance H between the anode electrode and the electron-emitting device is set to 2 mm and that a pressure in the vacuum apparatus is set to 1×10⁻⁶ Pa.

The electron-emitting device has a threshold voltage Vth as shown in FIG. 45. Thus, if a voltage lower than the threshold voltage Vth is applied between the electrodes 2 and 3, electrons are not emitted substantially. However, by applying a voltage higher than the threshold voltage Vth, the emission current (Ie) from the device and the device current (If) that flows between the electrodes 2 and 3 begin to develop. With the above characteristic, it is possible that an electron source in which a plurality of the above-described electron-emitting devices are arranged in matrix on the same substrate is structured to perform simple matrix drive in which a desired device is selected to be driven.

In the above example, description has been made of the case where the light absorber layer 9 is formed between the substrate 1 and the polymer film 6″. However, other structures are also provided.

In the electron-emitting device according to the present invention, the gap 5 needs to be an insulator in order to make the power applied at the time of drive small. Therefore, a technical device needs to be made for the structure in the case where insulating property of the light absorber is poor.

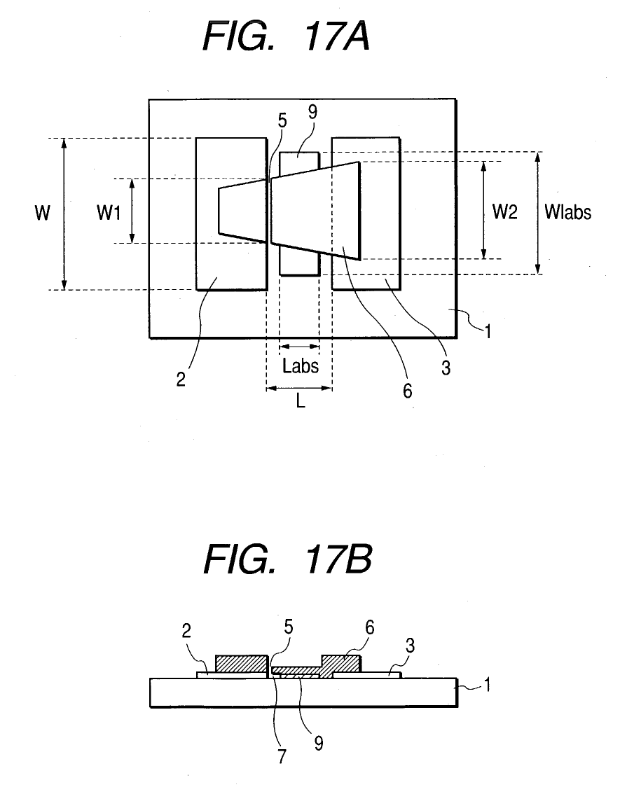

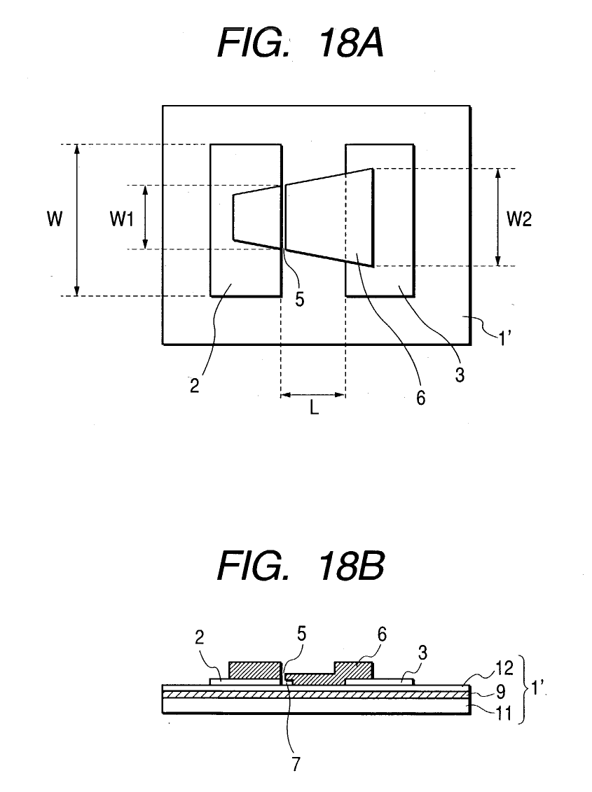

FIGS. 17A and 17B and FIGS. 18A and 18B each show a structure in the case of using the light absorber with poor insulating property.

FIGS. 17A and 17B show the case where the light absorber layer 9 is formed between the electrodes 2 and 3. A structure that keeps insulating property of the gap 5 is realized by electrically disconnecting the light absorber layer and the electrode. The thickness of the light absorber layer 9 is sufficiently made smaller than an electrode interval L, or the thickness of the substrate 1 is made sufficiently larger than that of the polymer film, whereby heat generated in the light absorber layer 9 can be applied to the polymer film.

FIGS. 18A and 18B show a case where the light absorber layer 9 is formed inside a substrate 1′. The substrate 1′ is constituted by a first substrate 11, the light absorber 9, and a second substrate 12. The light absorber layer 9 having poor insulating property is covered by the substrate 12 having high insulating property, thereby being capable of keeping insulating property of the gap 5. The thickness of the light absorber layer 9 is sufficiently made smaller than the electrode interval L, or the thickness of the substrate 12 is made sufficiently smaller than the electrode interval L, whereby heat generated in the light absorber layer 9 can be applied to the polymer film. Further, the thickness of the polymer film is sufficiently made larger than that of the substrate 1, whereby the heat generated in the light absorber layer 9 can be applied to the polymer film.

Next, when the light absorber exhibits effective insulating property, the substrate itself is imparted with a light absorption characteristic in some cases.

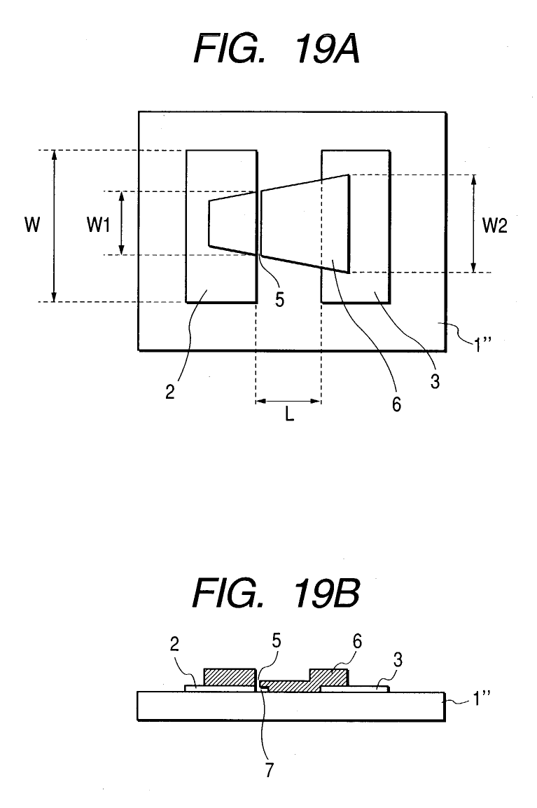

In FIGS. 19A and 19B, a case is shown in which the substrate 1″ is formed of a light absorber. The thickness of the substrate 1″ is sufficiently made larger than the electrode interval L, whereby the heat generated in the light absorber layer (substrate 1″) can be applied to the polymer film.

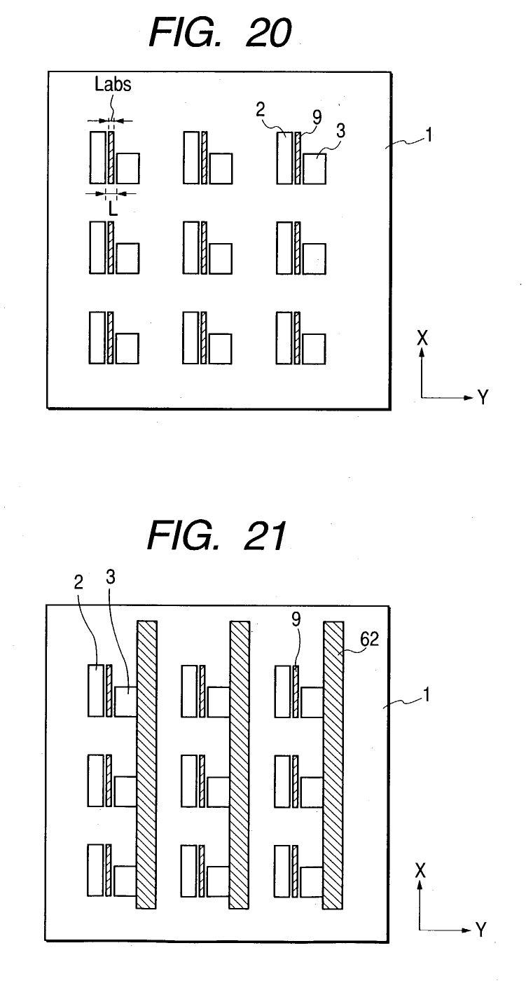

Next, an example of a method of manufacturing an electron source of the present invention using an electron-emitting device as shown in FIGS. 17A and 17B is shown below by using FIGS. 20 to 26 and the like.

(A2) First, a rear plate 1 is prepared. The rear plate 1 made of an insulating material is used, and particularly, the rear plate 1 made of glass is preferably used.

(B2) Next, a plurality of pairs of electrodes 2 and 3 and a light absorber layer 9, which are described with reference to FIGS. 17A and 17B, are formed on the rear plate 1 (FIG. 20). It is sufficient that the electrode material is a conductive material, but a material that does not receive damage due to the light irradiation described below is preferable. The light absorber layer 9 is a material for absorbing wavelength of the laser used in the modification described below. Further, various manufacturing methods such as a sputtering method, a CVD method, and a printing method can be used for the methods of forming the electrodes 2 and 3 and the light absorber layer 9. Note that, in FIG. 20, for simplifying the explanation, there is shown an example in which nine pairs of electrodes in total, i.e., three pairs of electrodes in an X direction and three pairs of electrodes in a Y direction, are formed. However, the number of the pairs of electrodes is appropriately defined depending on the resolution of an image-forming apparatus.

(C2) Next, a lower wiring 62 is formed so as to cover a part of the electrode 3 (FIG. 21). Various methods can be employed for a method of forming the lower wiring 62. Preferably, a printing method is used. Among printing methods, a screen printing method is preferable in the point that a large-area substrate can be formed at low cost.

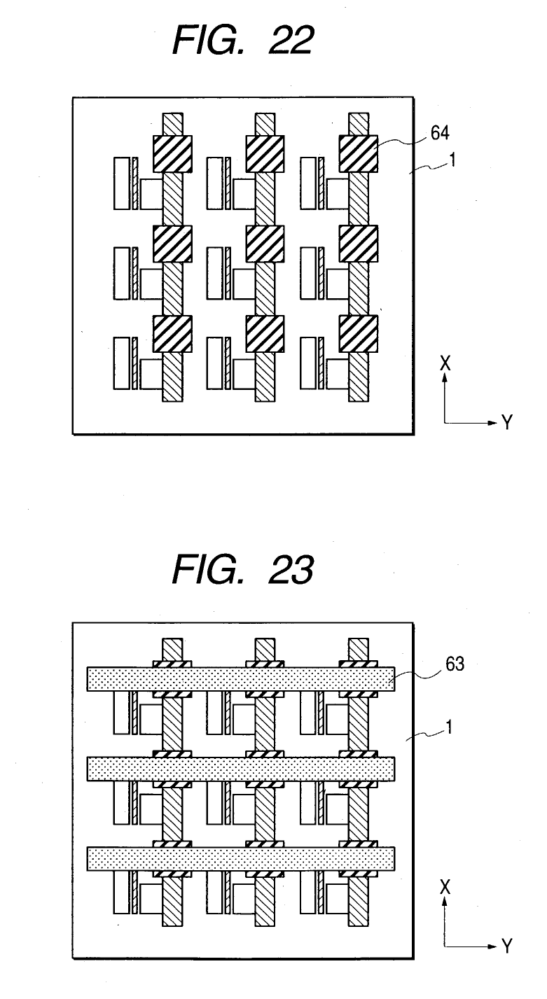

(D2) An insulating layer 64 is formed at an intersecting portion of the lower wiring 62 and an upper wiring 63 to be formed in the next step (FIG. 22). Various methods can also be employed for a method of forming the insulating layer 64. Preferably, a printing method is employed. Among printing methods, a screen printing method is preferable in the point that a large-area substrate can be formed at low cost.

(E2) The upper wiring 63 substantially orthogonal to the lower wiring 62 is formed (FIG. 23). Various methods can also be employed for a method of forming the upper wiring 63. Preferably, a printing method is employed similarly to the lower wiring 62. Among printing methods, a screen printing method is preferable in the point that a large-area substrate can be formed at low cost.

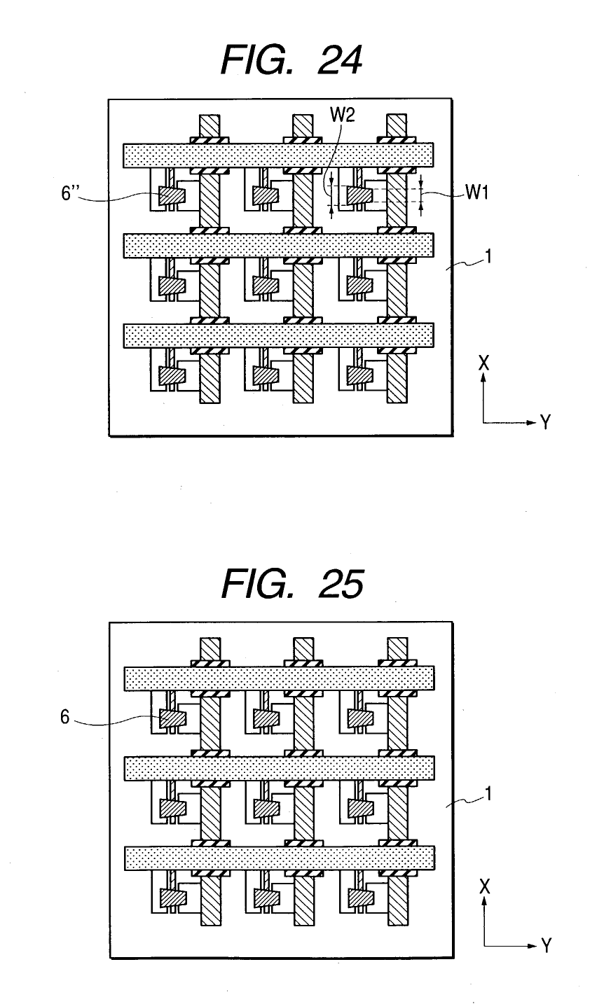

(F2) Next, a polymer film 6″ is formed so as to make a connection between the electrodes 2 and 3 of each pair (FIG. 24). An inkjet method can be used for simply and easily forming the polymer film 6″ in a large area. Also, patterning may be employed for forming the polymer film 6″ with a desired shape as described above.

(G2) Subsequently, as described above, a “resistance lowering process” is performed to lower the resistance of the polymer film 6″ as described above. The “resistance lowering process” is performed by irradiation of the above-described laser beam. The “resistance lowering process” is preferably performed in a reduced pressure atmosphere. This step allows the polymer film 6″ to have conductivity, so that the polymer film 6″ is converted into a conductive film 6 (FIG. 25). Specifically, the resistance value of the conductive film 6 is in the range of 10³ Ω/□ to 10⁷ Ω/□.

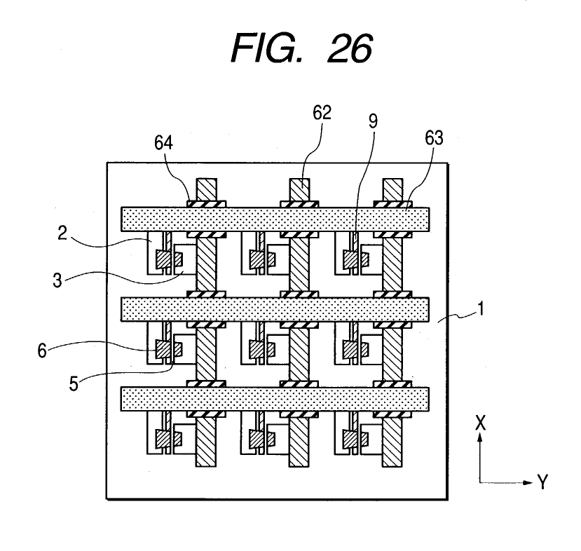

(H2) Next, a gap 5 is formed in the conductive film 6 (film obtained by subjecting the polymer film 6″ to resistance lowering) obtained in the step (G2). The formation of the gap 5 can be attained by applying a voltage to each of the wirings 62 and 63. Thus, the voltage is applied between the electrodes 2 and 3 of each pair. Note that the voltage to be applied is preferably a pulse voltage. The gap 5 is formed in a part of the conductive film 6 (film obtained by subjecting the polymer film 6′ to resistance lowering) by this voltage applying step (FIG. 26).

The voltage applying step may also be performed by successively applying voltage pulses between the electrodes 2 and 3 simultaneously with the above resistance lowering process, that is, during irradiation of laser. In any case, the voltage applying step is desirably performed under a reduced pressure atmosphere.

Through the above steps, an electron source provided with a plurality of electron-emitting devices on a substrate can be manufactured. Further, the above-described steps (I) to (J) are conducted by using the electron source, whereby the image-forming apparatus shown in FIG. 48 can be manufactured.

Embodiments

Hereinafter, the present invention will be described with embodiments in more detail.

Embodiment 1

In this embodiment, description will be made of an example in which an image-forming apparatus 100 schematically shown in FIG. 48 is manufactured by using an electron source in which a large number of electron-emitting devices, each of which is as shown in FIGS. 1A and 1B, are arranged.

FIG. 12 schematically shows an enlarged part of the electron source manufactured in this embodiment, which is constituted by a rear plate, a plurality of electron-emitting deices formed thereon, and wirings for applying signals to the plurality of electron-emitting devices. Note that reference numeral 1 denotes a rear plate (base plate), 2 and 3 denote electrodes, 5 denotes a gap, 6 denotes a conductive film containing carbon as its main constituent, 62 denotes an X-directional wiring, 63 denotes a Y-directional wiring, and 64 denotes an interlayer insulating layer.

In FIG. 48, the members denoted by the same reference numerals as those used in FIG. 12 indicate the same members in FIG. 12. Reference numeral 71 denotes a face plate in which a phosphor film 74 and a metal back 73 made of Al are laminated on a glass base plate. Reference numeral 72 denotes a supporting frame. The vacuum airtight container 100 (image-forming apparatus) is composed by the rear plate 1, the face plate 71, and the supporting frame 72.

Hereinafter, a method of manufacturing the image-forming apparatus in this embodiment will be described with reference to FIGS. 6 to 12, 14A and 14B, and 48.

(Step 1)

A platinum (Pt) film with a thickness of 50 nm was deposited on the glass base plate 1 by a sputtering method, and the electrodes 2 and 3 made of the Pt film were formed using a photolithography technique (FIG. 6). Here, the distance between the electrodes 2 and 3 was 10 μm.

(Step 2)

Next, a silver (Ag) paste is printed on the substrate 1 by a screen printing method and is then baked by the application of heat, whereby the X-directional wiring 62 is formed (FIG. 7).

(Step 3)

Subsequently, an insulating paste is printed on the position that is an intersecting portion of the X-directional wiring 62 and the Y-directional wiring 63 formed in the next step by a screen printing method, and is then baked by the application of heat, whereby the insulating layer 64 is formed (FIG. 8).

(Step 4)

Further, an Ag paste is printed by a screen printing method and is then baked by the application of heat, whereby the Y-directional wiring 63 is formed. Thus, matrix wirings are formed on the substrate 1 (FIG. 9).

(Step 5)

A solution of materials for a polymer film 6′ and a light absorber 8 was applied to the portion that extends over the electrodes 2 and 3 on the substrate 1 on which the matrix wirings were formed as described above by using an inkjet method. In this embodiment, a solution of polyamide acid that is a precursor of polyimide which is diluted with 3% Nmethylpyrrolidone/2-butoxy-ethanol is mixed with commercially available black inkjet ink (trade name: BJI-201BkHC; manufactured by Canon Inc.). The resultant solution was applied by the inkjet method. Then, the resultant was baked at 130° C. to remove the solvent, thereby forming the circular polymer film 6′ containing the light absorber in the polyimide precursor, which has a diameter of about 100 μm and a thickness of 30 nm (FIG. 10).

(Step 6)

Next, the rear plate 1 manufactured by the steps up through (Step 5) is arranged on a stage provided in a vacuum container, and pulse semiconductor laser (a wavelength of 810 nm, energy per pulse of 0.5 mJ, and a beam diameter of 100 μm) is irradiated to the polymer film 6′ through a quartz window of the vacuum container which is arranged just above the device. Then, the stage is moved, and a conductive region where thermal decomposition has progressed is formed in a part of the polymer film 6′.

(Step 7)

The supporting frame 72 and a spacer 101 are adhered onto the rear plate 1 manufactured as described above by means of a bonding member (frit glass). Arrangement is made such that the rear plate 1, which is adhered with the spacer and the supporting frame, and the face plate 71 face each other (the surface on which the phosphor film 74 and the metal back 73 are formed and the surface on which the wirings 62 and 63 and the like are formed face each other) (FIG. 14A). Note that frit glass was previously applied to a contact portion on the face plate 71 with the supporting frame 72.

(Step 8)

Next, seal bonding was performed by heating and pressurizing the opposing face plate 71 and rear plate 1 at 400° C. in a vacuum atmosphere at 10⁻⁶ Pa (FIG. 14B). An airtight container, inside of which is kept at a high vacuum, is obtained by this step. Note that, as the phosphor film 74, there was used one in which phosphors respectively emitting three primary colors (R, G, B) were arranged in stripe.

Finally, by applying bipolar rectangular pulses with a power of 25 V, a pulse width of 1 msec, and a pulse interval of 10 msec between the electrodes 2 and 3 through the X-directional wiring and the Y-directional wiring, the gap 5 was formed in the conductive film 6 containing carbon as its main constituent (refer to FIG. 12). Thus, the image-forming apparatus 100 (FIG. 48) in this embodiment was manufactured.

In the image-forming apparatus completed as described above, a desired electron-emitting device was selected to be applied with a voltage of 22 V through the X-directional wiring and the Y-directional wiring, and the metal back 73 was applied with a voltage of 8 kV through a high voltage terminal Hv. As a result, a bright and satisfactory image was displayed for a long time.

Embodiment 2

In this embodiment, the same steps as in Embodiment 1 were implemented from (Step 1) to (Step 4). Hereinafter, (Step 5) and the subsequent steps are described with reference to FIGS. 13, 14A and 14B, and 48.

(Step 5)

A solution of a material for a polymer film 6″ is applied to a portion that extends over the electrodes 2 and 3 on the substrate 1 on which the matrix wirings are formed, which has been manufactured through the steps up through (Step 4) by using an inkjet method. In this embodiment, a solution of polyamic acid that is a precursor of polyimide which is diluted with 3% Nmethylpyrrolidone/triethanol amine is used. The solution was applied and baked at 350° C., thereby forming the circular polymer film 6″ formed of polyimide, which has a diameter of about 100 μm and a thickness of 30 nm.

(Step 6)

Next, a methyl ethyl ketone solution with a commercially available phthalocyanine pigment (EXCOLOR No. 814k manufactured by Nippon Shokubai Co., Ltd.) was applied onto the polymer film manufactured by (Step 5), and the solvent was evaporated, thereby forming a light absorber material layer 9 with a thickness of 10 nm on the polymer film 6″.

(Step 7)

Subsequently, the rear plate 1 manufactured by the steps up through (Step 6) is arranged on a stage provided in a vacuum container, and xenon light (an output of 15 W and a beam diameter of 3.5 mm) is irradiated to each of plural polymer films 6″ through a quartz window of the vacuum container which is arranged just above the device. Then, the stage is moved, and a conductive region where thermal decomposition has progressed is formed in a part of the polymer film 6″.

(Step 8)

The supporting frame 72 and the spacer 101 were adhered onto the rear plate 1 manufactured as described above by means of frit glass. Arrangement is made such that the rear plate 1, which is adhered with the spacer and the supporting frame, and the face plate 71 face each other (the surface on which the phosphor film 74 and the metal back 73 are formed and the surface on which the wirings 62 and 63 and the like are formed face each other) (FIG. 14A). Note that frit glass was previously applied to a contact portion on the face plate 71 with the supporting frame 72.

(Step 9)

Next, seal bonding was performed by heating and pressurizing the opposing face plate 71 and rear plate 1 at 400° C. in a vacuum atmosphere at 10⁻⁶ Pa (FIG. 14B). An airtight container, inside of which is kept at a high vacuum, is obtained by the step. Note that, as the phosphor film 74, there was used one in which phosphors respectively emitting three primary colors (R, G, B) were arranged in stripe.

Finally, by applying bipolar rectangular pulses with a power of 25 V, a pulse width of 1 msec, and a pulse interval of 10 msec between the electrodes 2 and 3 through the X-directional wiring and the Y-directional wiring, the gap 5 was formed in the conductive film 6 containing carbon as its main constituent (refer to FIG. 12). Thus, the image-forming apparatus 100 in this embodiment was manufactured.

In the image-forming apparatus completed as described above, a desired electron-emitting device was selected to be applied with a voltage of 22 V through the X-directional wiring and the Y-directional wiring, and the metal back 73 was applied with a voltage of 8 kV through a high voltage terminal Hv. As a result, a bright and satisfactory image was displayed for a long time.

Embodiment 3

This embodiment has a characteristic that light-thermal conversion of the second harmonic of a YAG laser in a step of modifying a polymer film is efficiently performed by using amorphous silicon for a light absorber layer.

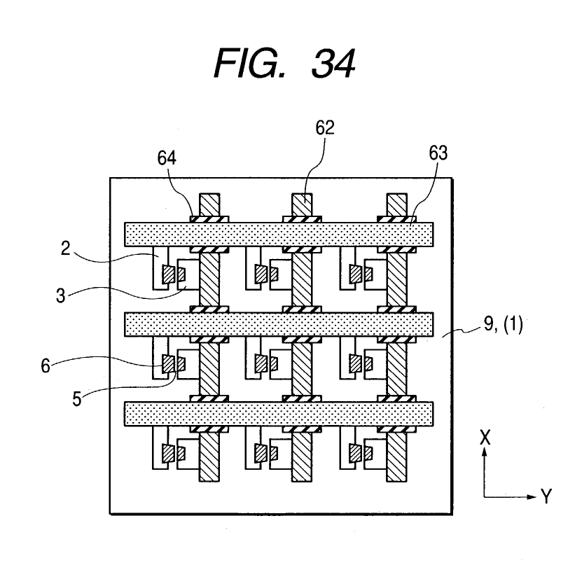

In this embodiment, description will be made of an example in which an image-forming apparatus 100 schematically shown in FIG. 48 is manufactured by using an electron source as shown in FIG. 34.

FIG. 34 schematically shows a part of the electron source manufactured in this embodiment, which is constituted by a rear plate, a plurality of electron-emitting devices formed thereon, and wirings for applying signals to the plurality of electron-emitting devices. Reference numeral 1 denotes a rear plate (base plate) on which a light absorber 9 is formed, 2 and 3 denote electrodes, 5 denotes a gap, 6 denotes a conductive film containing carbon as its main constituent, 62 denotes an X-directional wiring, 63 denotes a Y-directional wiring, and 64 denotes an interlayer insulating layer.

In FIG. 48, the members denoted by the same reference numerals as those used in FIG. 34 indicate the same members in FIG. 34. Reference numeral 71 denotes a face plate in which a phosphor film 74 and a metal back 73 made of Al are laminated on a glass base plate. Reference numeral 72 denotes a supporting frame. The vacuum airtight container 100 (image-forming apparatus) is composed by the rear plate 1, the face plate 71, and the supporting frame 72.

Hereinafter, a method of manufacturing the image-forming apparatus in this embodiment will be described with reference to FIGS. 28 to 34, 35A through 35F, 14A and 14B, and 48.

(Step 1)

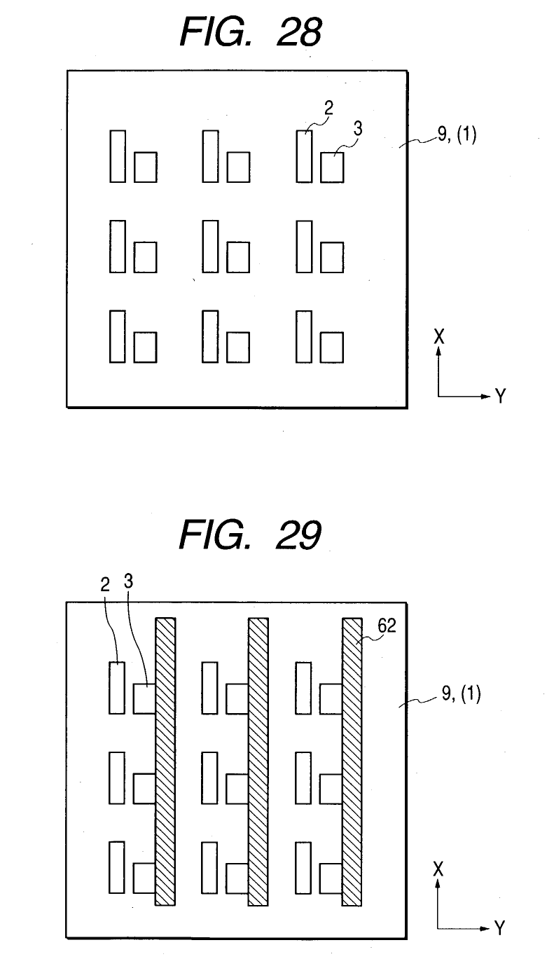

Amorphous silicon with a thickness of 100 nm was deposited over the entire surface of the glass base plate 1 with a thickness of 1.1 mm by a plasma CVD method to thereby form the light absorber layer 9. Thereafter, a 100 nm thick Pt film was deposited thereon by a sputtering method to form the electrodes 2 and 3 made of the Pt film with the use of a photolithography technique (FIG. 28). Here, the distance between the electrodes 2 and 3 was 10 μm.

(Step 2)

Next, an Ag paste is printed by a screen printing method and is then baked by the application of heat, whereby the X-directional wiring 62 is formed (FIG. 29).

(Step 3)

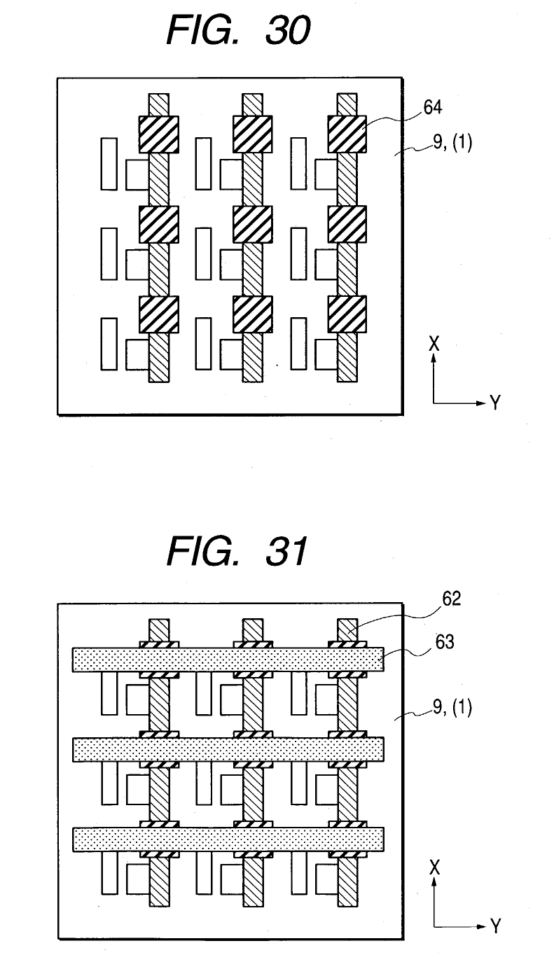

Subsequently, an insulating paste is printed on the position that is an intersecting portion of the X-directional wiring 62 and the Y-directional wiring 63 formed in the next step by a screen printing method, and is then baked by the application of heat, whereby the insulating layer 64 is formed (FIG. 30).

(Step 4)

Further, an Ag paste is printed by a screen printing method and is then baked by the application of heat, whereby the Y-directional wiring 63 is formed. Thus, matrix wirings are formed on the substrate 1 (FIG. 31).

(Step 5)

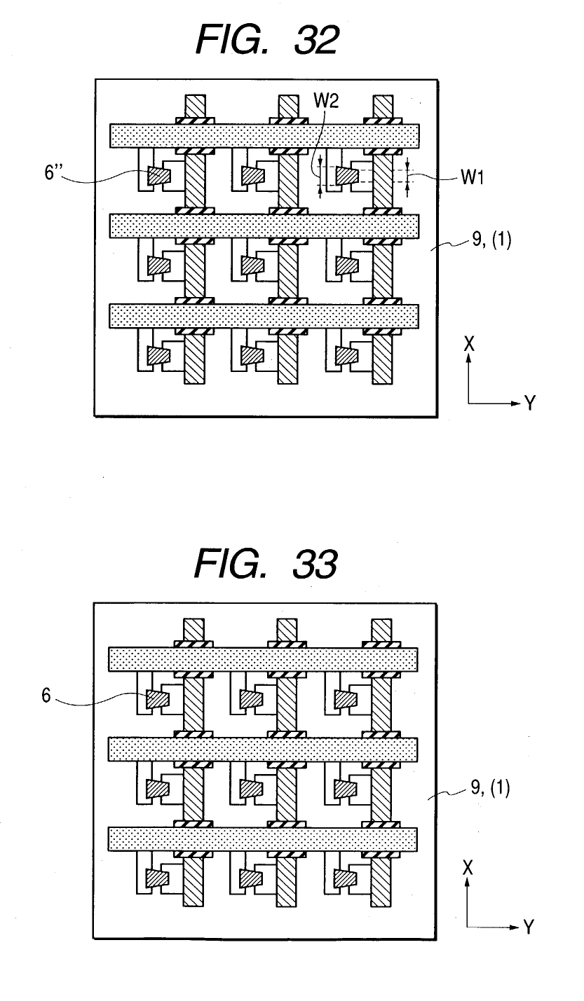

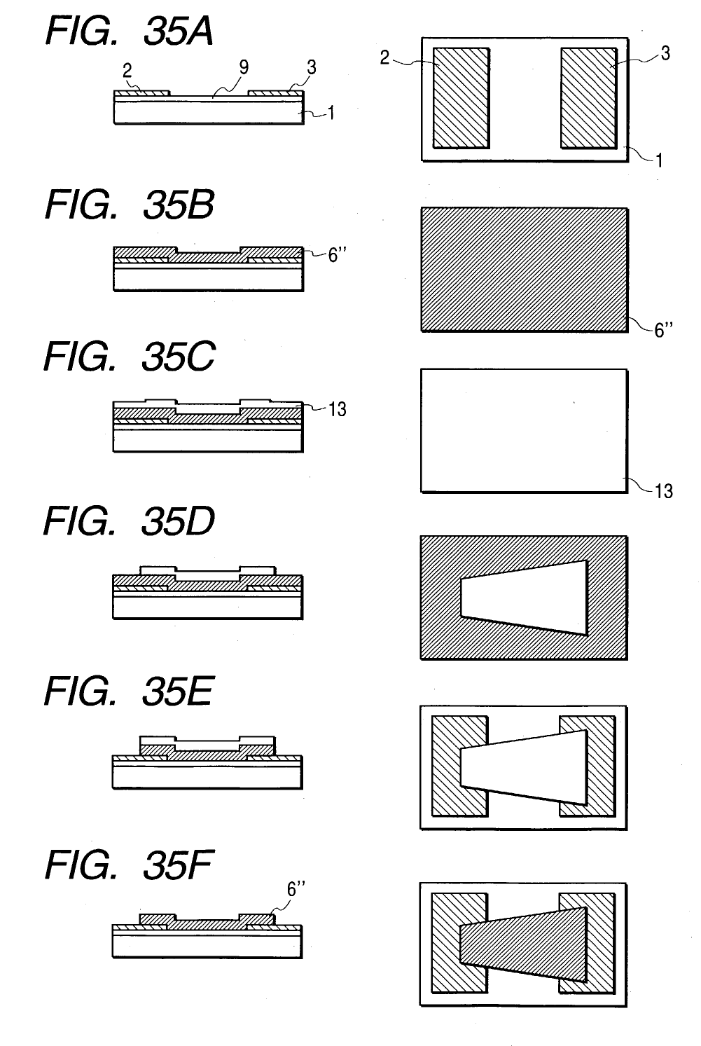

A polymer film 6″ is arranged at a portion that extends over the electrodes 2 and 3 on the substrate 1 on which the matrix wirings are formed, which has been manufactured as described above (FIG. 32). A method of forming the polymer film 6” will be specifically described with reference to FIGS. 35A to 35F. Note that FIGS. 35A to 35F show only a region for one device.

First, a solution of polyamic acid (manufactured by Hitachi Chemical Co., Ltd.: PIX-L110) that is an aromatic polyimide precursor which is diluted with a 3% N-methylpyrrolidone solvent dissolved with triethanolamine was applied over the entire surface of the substrate 1 formed with the matrix wirings by means of a spin coater, and the resultant substrate 1 was baked while a temperature rises up to 350° C. under a vacuum condition to be made into an imide form (FIG. 35B). Thereafter, photoresist 13 is applied (FIG. 35C), and steps of exposure (not shown in the figure), developing (FIG. 35D), and etching (FIG. 35E) are performed, whereby the polyimide film is patterned into a trapezoid shape so as to extend over the electrodes 2 and 3 to form the polymer film 6″ with a trapezoid shape (FIG. 35F). At this time, the thickness of the polyimide film (polyimide film 6″) was 30 nm. Further, W1 and W2, which are shape parameters of polyimide, are respectively set to 60 μm and 120 μm. These parameters are set in order to form the gap on the WI side.

(Step 6)

Next, the rear plate 1 on which the electrodes 2 and 3 made of Pt, the matrix wirings 62 and 63, and the polymer film 6″ formed of the polyimide film are formed is placed on a stage (in the air), and the second harmonic (SHG) of Q switch pulse Nd:YAG laser (a pulse width of 100 nm, energy per pulse of 0.5 mJ, and a beam diameter of 10 μm) is irradiated to the polymer film 6″. At this time, the stage is moved, and irradiation is performed with a width of 10 μm with respect to the polymer film 6″ in a direction from the electrode 2 to the electrode 3. Thus, a region where thermal decomposition has progressed is formed in a part of the polymer film 6″. In this embodiment, a step of converting light into heat is promoted by providing the light absorber layer 9. Thus, modification can be uniformly realized for a short time in comparison with the case where the light absorber layer is not provided (FIG. 33).

(Step 7)

The supporting frame 72 and a spacer 101 were adhered onto the rear plate 1 manufactured as described above by means of frit glass. Arrangement is made such that the rear plate 1, which is adhered with the spacer and the supporting frame, and the face plate 71 face each other (the surface on which the phosphor film 74 and the metal back 73 are formed and the surface on which the wirings 62 and 63 are formed face each other) (FIG. 14A). Note that frit glass was previously applied to a contact portion on the face plate 71 with the supporting frame 72.

(Step 8)

Next, seal bonding was performed by heating and pressurizing the opposing face plate 71 and rear plate 1 at 400° C. in a vacuum atmosphere at 10⁻⁶ Pa (FIG. 14B). An airtight container, inside of which is kept at a high vacuum, is obtained by the step. Note that, as the phosphor film 74, there was used one in which phosphors respectively emitting three primary colors (R, G, B) were arranged in stripe.

Finally, by applying bipolar rectangular pulses with a power of 25 V, a pulse width of 1 msec, and a pulse interval of 10 msec between the electrodes 2 and 3 of each pair through the X-directional wiring and the Y-directional wiring, the gap 5 was formed in the conductive film 6 containing carbon as its main constituent (refer to FIG. 34). Thus, the image-forming apparatus 100 (FIG. 48) in this embodiment was manufactured.

In the image-forming apparatus completed as described above, a desired electron-emitting device was selected to be applied with a voltage of 22 V through the X-directional wiring and the Y-directional wiring, and the metal back 73 was applied with a voltage of 8 kV through a high voltage terminal Hv. As a result, a bright and satisfactory image was displayed for a long time.

In this embodiment, amorphous silicon is deposited as the light absorber layer 9, and the second harmonic (SHG) of the YAG layer was used for modification of the polymer film. However, a light absorber and a wavelength range of irradiation light are not limited to these, and are appropriately selected.

For example, an absorption wavelength can be changed with a band engineering technique by using a multi compound semiconductor as a light absorber. Thus, the wavelength of the light used in modification can be adapted for the wavelength of the light to be absorbed.

Further, an insulator can be used as the light absorber. For example, (Al2O3:Fe) or the like having a light absorption characteristic in a visible light region is used, thereby enabling modification with the light of the wavelength of the visible light region.

Moreover, also in the case where a light source of halogen, xenon, or deuterium with a non-single wavelength is used as a light source, the light absorber layer is effective. In order to make the light absorber layer absorb a large number of wavelength ranges, a light absorber layer is formed to have multi layers, and this is more preferably implemented by using absorbing materials having different wavelengths for the respective layers.

Embodiment 4

Driving power may be increased depending on the resistance value of a light absorber in the case where image display drive is performed with the substrate structure as in Embodiment 3. This point is improved in this embodiment. Note that, also in this embodiment, amorphous silicon is used for a light absorber layer and the second harmonic of a YAG laser is used as laser source.

FIG. 26 schematically shows an enlarged part of the electron source manufactured in this embodiment, which is constituted by a rear plate, a plurality of electron-emitting devices formed thereon, and wirings for applying signals to the plurality of electron-emitting devices. Reference numeral 1 denotes a rear plate (base plate), 2 and 3 denote electrodes, 5 denotes a gap, 6 denotes a conductive film containing carbon as its main constituent, 62 denotes an X-directional wiring, 63 denotes a Y-directional wiring, and 64 denotes an interlayer insulating layer.

Hereinafter, a method of manufacturing an image-forming apparatus in this embodiment will be described with reference to FIGS. 20 to 26, 27A through 27F, 14A and 14B, and 48.

(Step 1)

Amorphous silicon with a thickness of 100 nm was deposited over the entire surface of the glass base plate 1 with a thickness of 1.1 mm by a plasma CVD method, and patterning was performed using a photolithography technique such that has a length of 5 μm to form a light absorber layer 9. Thereafter, a 100 nm thick Pt film was deposited thereon by a sputtering method to form the electrodes 2 and 3 made of the Pt film with the use of a photolithography technique (FIG. 20). Here, the distance L between the electrodes 2 and 3 was 10 μm.

(Step 2)

Next, an Ag paste is printed by a screen printing method and is then baked by the application of heat, whereby the X-directional wiring 62 is formed (FIG. 21).

(Step 3)

Subsequently, an insulating paste is printed on the position that is an intersecting portion of the X-directional wiring 62 and the Y-directional wiring 63 formed in the next step by a screen printing method, and is then baked by the application of heat, whereby the insulating layer 64 is formed (FIG. 22).

(Step 4)

Further, an Ag paste is printed by a screen printing method and is then baked by the application of heat, whereby the Y-directional wiring 63 is formed. Thus, matrix wirings are formed on the substrate 1 (FIG. 23).

(Step 5)

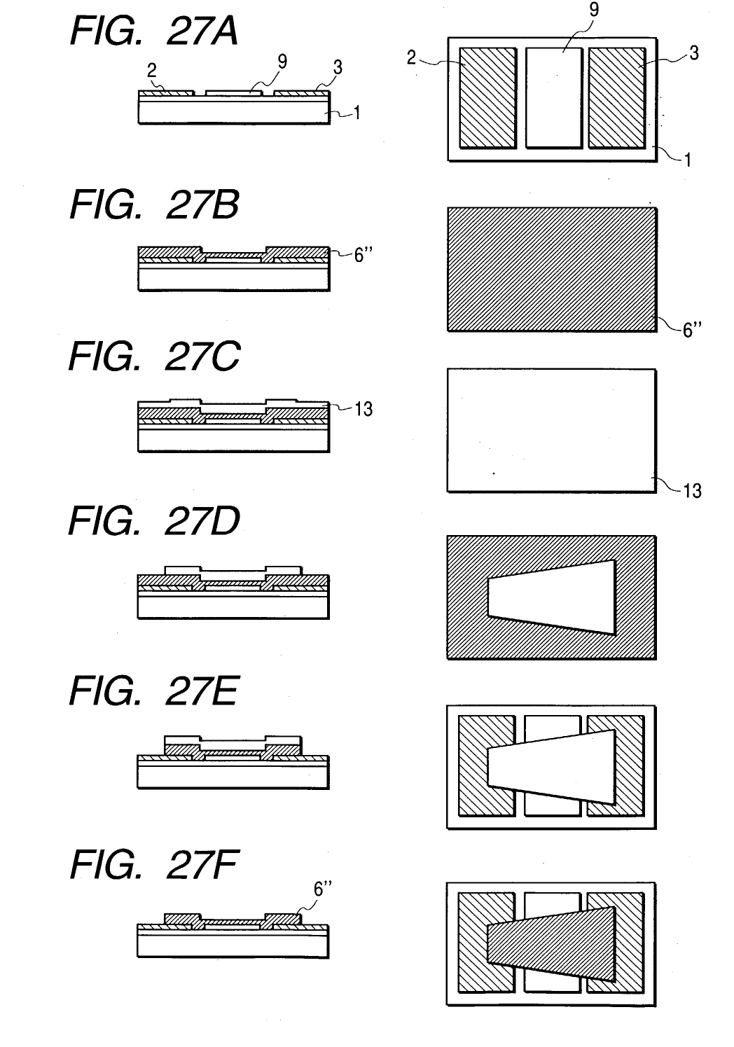

A polymer film 6″ is arranged at a portion that extends over the electrodes 2 and 3 on the substrate 1 on which the matrix wirings are formed, which has been manufactured as described above (FIG. 24). A method of forming the polymer film 6″ will be specifically described with reference to FIGS. 27A to 27F. Note that FIGS. 27A to 27F show only a region for one device.

First, a solution of polyamic acid (manufactured by Hitachi Chemical Co., Ltd.: PIX-L110) that is an aromatic polyimide precursor which is diluted with a 3% N-methylpyrrolidone solvent dissolved with triethanolamine was applied over the entire surface of the substrate 1 formed with the matrix wirings by means of a spin coater, and the resultant substrate 1 was baked while a temperature rises up to 350° C. under a vacuum condition to be made into an imide form (FIG. 27B). Thereafter, photoresist 13 is applied (FIG. 27C), and steps of exposure (not shown in the figure), developing (FIG. 27D), and etching (FIG. 27E) are performed, whereby the polyimide film is patterned into a trapezoid shape so as to extend over the electrodes 2 and 3 to form the polymer film 6″ with a trapezoid shape (FIG. 27F). At this time, the thickness of the polyimide film (polyimide film 6″) was 30 nm. Further, W1 and W2, which are shape parameters of polyimide, are respectively set to 60 μm and 120 μm. These parameters are set in order to form the gap on the W1 side.

(Step 6)

Next, the rear plate 1 on which the electrodes 2 and 3 made of Pt, the matrix wirings 62 and 63, and the polymer film 6″ formed of the polyimide film are formed is placed on a stage (in the air), and the second harmonic (SHG) of Q switch pulse Nd:YAG laser (a pulse width of 100 nm, energy per pulse of 0.5 mJ, and a beam diameter of 10 μm) is irradiated to the polymer film 6′. At this time, the stage is moved, and irradiation is performed with a width of 10 μm with respect to the polymer film 6″ in a direction from the electrode 2 to the electrode 3. Thus, a conductive region where thermal decomposition has progressed is formed in a part of the polymer film 6″. In this embodiment, a step of converting light into heat is promoted by providing the light absorber layer 9. Thus, modification can be uniformly realized for a short time in comparison with the case where the light absorber layer is not provided (FIG. 25).

(Step 7)

The supporting frame 72 and a spacer 101 were adhered onto the rear plate 1 manufactured as described above by means of frit glass. Arrangement is made such that the rear plate 1, which is adhered with the spacer and the supporting frame, and the face plate 71 face to each other (the surface on which the phosphor film 74 and the metal back 73 are formed and the surface on which the wirings 62 and 63 are formed face to each other) (FIG. 14A). Note that frit glass was previously applied to a contact portion on the face plate 71 with the supporting frame 72.

(Step 8)

Next, seal bonding was performed by heating and pressurizing the opposing face plate 71 and rear plate 1 at 400° C. in a vacuum atmosphere at 10⁻⁶ Pa (FIG. 14B). An airtight container, inside of which is kept at a high vacuum, is obtained by this step. Note that, as the phosphor film 74, there was used one in which phosphors respectively emitting three primary colors (R, G, B) were arranged in stripe.

Finally, by applying bipolar rectangular pulses with a power of 25 V, a pulse width of 1 msec, and a pulse interval of 10 msec between the electrodes 2 and 3 through the X-directional wiring and the Y-directional wiring, the gap 5 was formed in the conductive film 6 containing carbon as its main constituent (refer to FIG. 26). Thus, the image-forming apparatus 100 (FIG. 48) in this embodiment was manufactured.

In the image-forming apparatus completed as described above, a desired electron-emitting device was selected to be applied with a voltage of 22 V through the X-directional wiring and the Y-directional wiring, and the metal back 73 was applied with a voltage of 8 kV through a high voltage terminal Hv. As a result, a bright and satisfactory image was displayed for a long time.

In this embodiment, the structure for maintaining insulating property of the gap 5 is realized by particularly forming the light absorber layer 9 between the electrodes 2 and 3 and electrically disconnecting between the light absorber layer 9 and the electrodes. Thus, the current that flows through the light absorber layer 9 can be suppressed, and driving power can be prevented from increasing.

Embodiment 5

This embodiment copes with a problem in that the resistance value of a light absorber increases driving power similarly to Embodiment 4. Further, in this embodiment, since there is no need to perform patterning of the light absorber layer, the process can be simplified.

Note that, in this embodiment as well, amorphous silicon is used for a light absorber layer and the second harmonic of a YAG laser is used as laser source.

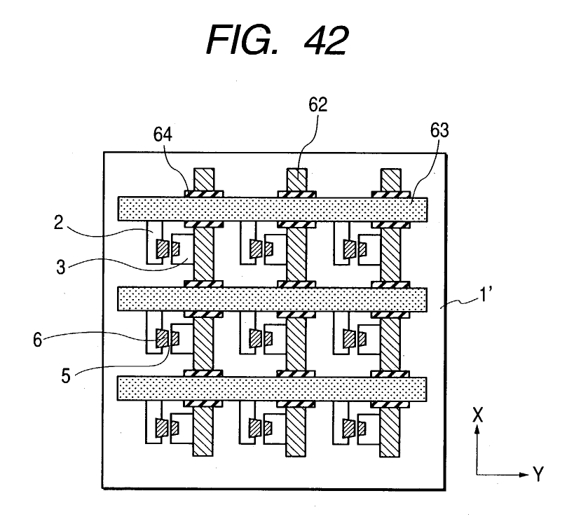

FIG. 42 schematically shows an enlarged part of the electron source manufactured in this embodiment, which is constituted by a rear plate, a plurality of electron-emitting devices formed thereon, and wirings for applying signals to the plurality of electron-emitting devices. Reference numeral 1′ denotes a rear plate (substrate), 2 and 3 denote electrodes, 5 denotes a gap, 6 denotes a conductive film containing carbon as its main constituent, 62 denotes an X-directional wiring, 63 denotes a Y-directional wiring, and 64 denotes an interlayer insulating layer.

Hereinafter, a method of manufacturing an image-forming apparatus in this embodiment will be described with reference to FIGS. 36 to 42, 43-0 and 43-1, 43A through 43F, 14A and 14B, and 48.

(Step 1)

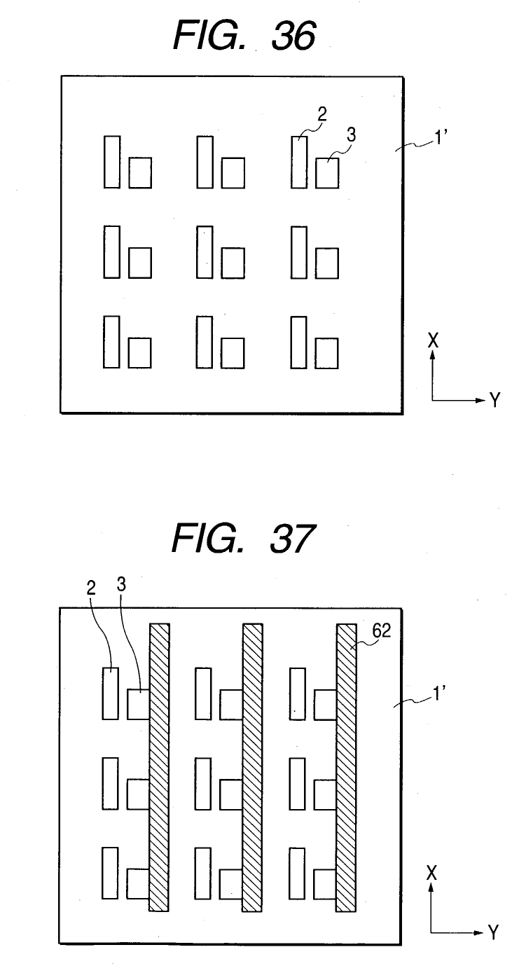

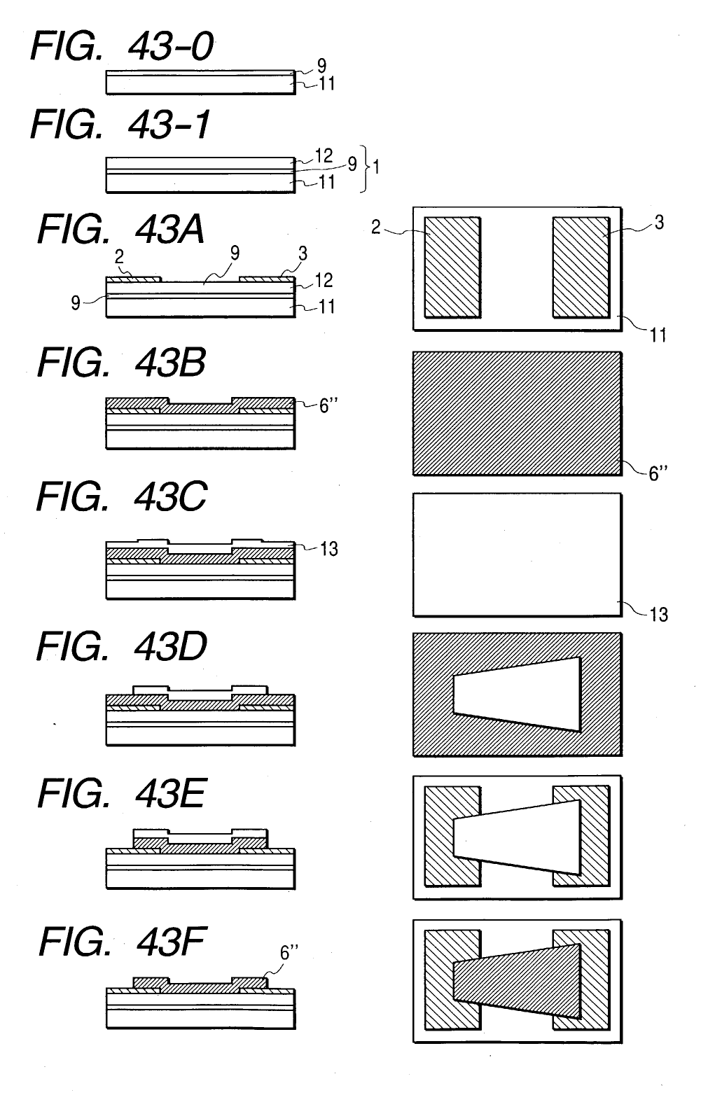

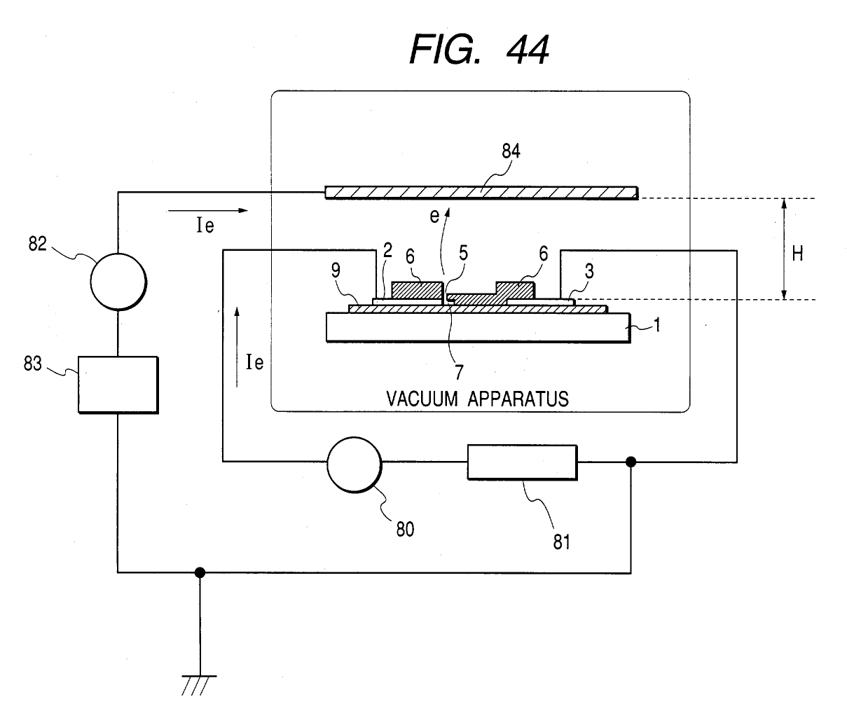

Amorphous silicon with a thickness of 100 nm was deposited over the entire surface of a glass base plate 11 with a thickness of 1.1 mm by a plasma CVD method to thereby form a light absorber layer 9 (FIGS. 43-0). Thereafter, a 100 nm thick SiO2 film was deposited on amorphous silicon (light absorber layer 9) to form an insulating layer 12 (FIGS. 43-1). Thus, the substrate 1′ constituted by the glass base plate 11, the light absorber layer 9, and the insulating layer 12 was obtained. Then, a Pt film with a thickness of 100 nm was deposited by a sputtering method to form the electrodes 2 and 3 formed of the Pt film with the use of a photolithography technique (FIG. 36). Here, the distance L between the electrodes 2 and 3 was 10 μm.

(Step 2)

Next, an Ag paste is printed by a screen printing method and is then baked by the application of heat, whereby the X-directional wiring 62 is formed (FIG. 37).

(Step 3)

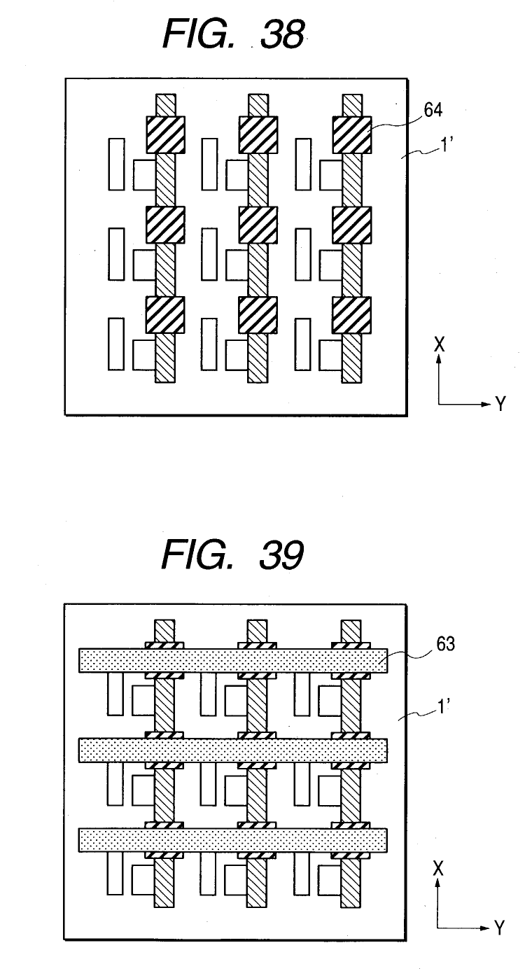

Subsequently, an insulating paste is printed on the position that is an intersecting portion of the X-directional wiring 62 and the Y-directional wiring 63 formed in the next step by a screen printing method, and is then baked by the application of heat, whereby the insulating layer 64 is formed (FIG. 38).

(Step 4)

Further, an Ag paste is printed by a screen printing method and is then baked by the application of heat, whereby the Y-directional wiring 63 is formed. Thus, matrix wirings are formed on the substrate 1′ (FIG. 39).

(Step 5)

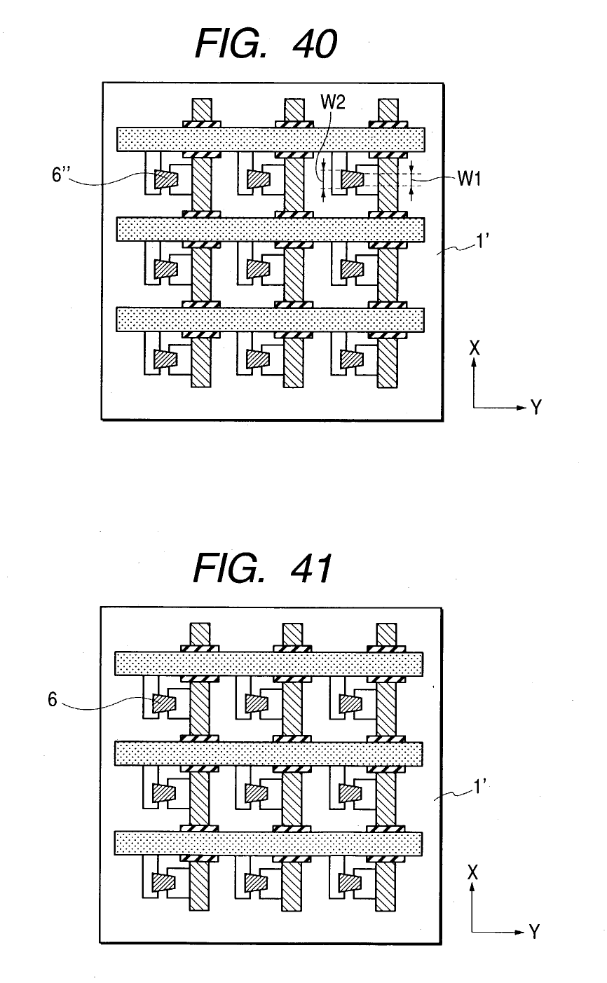

A polymer film 6″ is arranged at a portion that extends over the electrodes 2 and 3 on the substrate 1′ on which the matrix wirings are formed, which has been manufactured as described above (FIG. 40). A method of forming the polymer film 6″ will be specifically described with reference to FIGS. 43A to 43F. Note that FIGS. 43A to 43F show only a region for one device.

First, a solution of polyamic acid (manufactured by Hitachi Chemical Co., Ltd.: PIX-L110) that is an aromatic polyimide precursor which is diluted with a 3% N-methylpyrrolidone solvent dissolved with triethanolamine was applied over the entire surface of the substrate 1′ formed with the matrix wirings by means of a spin coater, and the resultant substrate 1′ was baked while a temperature rises up to 350° C. under a vacuum condition to be made into an imide form (FIG. 43B). Thereafter, photoresist 13 is applied (FIG. 43C), and steps of exposure (not shown in the figure), developing (FIG. 43D), and etching (FIG. 43E) are performed, whereby the polyimide film is patterned into a trapezoid shape so as to extend over the electrodes 2 and 3 to form the polymer film 6″ with a trapezoid shape (FIG. 43F). At this time, the thickness of the polyimide film (polyimide film 6″) was 30 nm. Further, W1 and W2, which are shape parameters of polyimide, are respectively set to 60 μm and 120 μm. These parameters are set in order to form the gap on the W1 side.

(Step 6)

Next, the rear plate 1′ on which the electrodes 2 and 3 made of Pt, the matrix wirings 62 and 63, and the polymer film 6″ formed of the polyimide film are formed is placed on a stage (in the air), and the second harmonic (SHG) of Q switch pulse Nd:YAG laser (a pulse width of 100 nm, energy per pulse of 0.5 mJ, and a beam diameter of 10 μm) is irradiated to the polymer film 6′. At this time, the stage is moved, and irradiation is performed with a width of 10 μm with respect to the polymer film 6″ in a direction from the electrode 2 to the electrode 3. Thus, a conductive region where thermal decomposition has progressed is formed in a part of the polymer film 6″. In this embodiment, a step of converting light into heat is promoted by providing the light absorber layer 9. Thus, modification can be uniformly realized for a short time in comparison with the case where the light absorber layer is not provided (FIG. 41).

(Step 7)

The supporting frame 72 and a spacer 101 were adhered onto the rear plate 1′ manufactured as described above by means of frit glass. Arrangement is made such that the rear plate 1′, which is adhered with the spacer and the supporting frame, and the face plate 71 face to each other (the surface on which the phosphor film 74 and the metal back 73 are formed and the surface on which the wirings 62 and 63 are formed face to each other) (FIG. 14A). Note that frit glass was previously applied to a contact portion on the face plate 71 with the supporting frame 72.

(Step 8)

Next, seal bonding was performed by heating and pressurizing the opposing face plate 71 and rear plate 1′ at 400° C. in a vacuum atmosphere at 10⁻⁶ Pa (FIG. 14B). An airtight container, inside of which is kept at a high vacuum, is obtained by the step. Note that, as the phosphor film 74, there was used one in which phosphors respectively emitting three primary colors (R, G, B) were arranged in stripe.

Finally, by applying bipolar rectangular pulses with a power of 25 V, a pulse width of 1 msec, and a pulse interval of 10 msec between the electrodes 2 and 3 through the X-directional wiring and the Y-directional wiring, the gap 5 was formed in the conductive film 6 containing carbon as its main constituent (refer to FIG. 42). Thus, the image-forming apparatus 100 (refer to FIG. 48) in this embodiment was manufactured.

In the image-forming apparatus completed as described above, a desired electron-emitting device was selected to be applied with a voltage of 22 V through the X-directional wiring and the Y-directional wiring, and the metal back 73 was applied with a voltage of 8 kV through a high voltage terminal Hv. As a result, a bright and satisfactory image was displayed for a long time.

Embodiment 6

This embodiment has a characteristic that a substrate itself is imparted with a light absorption characteristic, which is different from Embodiments 2 to 5 in which a light absorber layer is arranged. Therefore, steps are simplified in comparison with the above-described embodiments.

This embodiment is the same as Embodiment 5 except for the substrate structure. Thus, description of the respective manufacturing steps is omitted here.

In this embodiment, a glass base plate containing a colorant in its substrate is used. Ni is used as the colorant, whereby the wavelength range and the absorption range of the laser used in modification are made to correspond to each other. The light used in this embodiment is the second harmonic of a YAG laser.

In this embodiment, since the substrate itself corresponds to a light absorber, a case may occur in which heat is generated in the portion other than a device portion, which leads to substrate breakdown when the portion other than the device portion is irradiated with light. Thus, laser irradiation is performed to only the portion where a polymer film exists.

In this embodiment, since the substrate itself has a light absorption characteristic, the substrate structure becomes simpler. As a result, manufacturing is performed easily in comparison with Embodiment 5.

The materials used for the substrate include not only glass mixed with a colorant described above but also other materials as long as they are ones that have insulating property and easily absorb light. For example, green sapphire (Al₂O₃:Fe), blue sapphire (Al₂O₃:Ti), or ruby (Al₂O₃:Cr) may be used.

Embodiment 7

In this embodiment, description will be made of an example in which the image-forming apparatus 100 schematically shown in FIG. 48 is manufactured using an electron source structured by arranging a large number of electron-emitting devices as shown in FIGS. 1A and 1B.

FIG. 12 schematically shows an enlarged part of the electron source manufactured in this embodiment, which is constituted by a rear plate, a plurality of electron-emitting deices formed thereon, and wirings for applying signals to the plurality of electron-emitting devices. Note that reference numeral 1 denotes a rear plate (base plate), 2 and 3 denote electrodes, 5 denotes a gap, 6 denotes a conductive film containing carbon as its main constituent, 62 denotes an X-directional wiring, 63 denotes a Y-directional wiring, and 64 denotes an interlayer insulating layer.

In FIG. 48, the members denoted by the same reference numerals as those used in FIG. 12 indicate the same members in FIG. 12. Reference numeral 71 denotes a face plate in which a phosphor film 74 and a metal back 73 made of Al are laminated on a glass base plate. Reference numeral 72 denotes a supporting frame. The vacuum airtight container 100 (image-forming apparatus) is composed by the rear plate 1, the face plate 71, and the supporting frame 72.

Hereinafter, a method of manufacturing the image-forming apparatus in this embodiment will be described with reference to FIGS. 6 to 12, 14A and 14B, and 48.

(Step 1)

A silicon oxide film with a thickness of 0.5 μm was formed on a high-strain point glass base plate (manufactured by Asahi Glass Co., Ltd., PD200, a softening point of 830° C., an annealing point of 620° C., and a strain point of 570° C.), which had been cleaned, by using a sputtering method. A 50 nm thick Pt film was deposited thereon by a sputtering method, and the electrodes 2 and 3 made of the Pt film were formed by using a photolithography technique (FIG. 6). Here, the distance between the electrodes 2 and 3 was 10 μm.

(Step 2)

Next, a silver (Ag) paste is printed by a screen printing method and is then baked by the application of heat, whereby the X-directional wiring 62 is formed (FIG. 7).

(Step 3)

Subsequently, an insulating paste is printed on the position that is an intersecting portion of the X-directional wiring 62 and the Y-directional wiring 63 formed in the next step by a screen printing method, and is then baked by the application of heat, whereby the insulating layer 64 is formed (FIG. 8).

(Step 4)

Further, an Ag paste is printed by a screen printing method and is then baked by the application of heat, whereby the Y-directional wiring 63 is formed. Thus, matrix wirings are formed on the substrate 1 (FIG. 9).

(Step 5)

A solution of a material for a polymer film 6′ was applied to the portion that extends over the electrodes 2 and 3 on the substrate 1 on which the matrix wirings were formed as described above by using an inkjet method. In this embodiment, a solution of polyamide acid that is a precursor of polyimide which is diluted with 3% Nmethylpyrrolidone/2-butoxy-ethanol was applied by an inkjet method. The solution was baked at 130° C. to remove the solvent, thereby forming the circular polyamide acid polymer film 6′ that has a diameter of about 100 μm and a thickness of 60 nm (FIG. 10).

(Step 6)

Next, the rear plate 1 manufactured by the steps up through (Step 5) was immersed in an aqueous solution of tetraamine acetate platinum (II) complex (Chem. A) which was prepared with a metal molarity of 5×10⁻² mol/L for 10 minutes, whereby the metal complex was absorbed into the polymer film 6′. Next, the rear plate 1 was dried at 80° C., thereby obtaining the polyamide acid polymer film 6′ containing the Pt complex.

(Chem. A) [Pt(NH₃)₄]²+[CH₃COO—]₂

(Step 7)

Next, the rear plate 1 manufactured by the steps up through (Step 6) was installed with respect to an electron beam irradiation apparatus shown in FIG. 49, and the polymer film 6′ was subjected to a resistance lowering process by being irradiated with an electron beam. At this time, the pressure inside the apparatus was set to 1×10⁻³ Pa or less. An acceleration voltage of the electron beam was set to 8 kV, and the polymer film 6′ was irradiated with the electron beam through a slit. After the resistance lowering process, the sheet resistance of the conductive film 6 was measured, as a result of which the value was 10⁴ Ω/□.

(Step 8)

The supporting frame 72 and a spacer 101 are adhered onto the rear plate 1 manufactured as described above by means of a bonding member (frit glass). Arrangement is made such that the rear plate 1, which is adhered with the spacer and the supporting frame, and the face plate 71 face to each other (the surface on which the phosphor film 74 and the metal back 73 are formed and the surface on which the wirings 62 and 63 and the like are formed face to each other) (FIG. 14A). Note that frit glass was previously applied to a contact portion on the face plate 71 with the supporting frame 72.

(Step 9)

Next, seal bonding was performed by heating and pressurizing the opposing face plate 71 and rear plate 1 at 400° C. in a vacuum atmosphere at 10⁻⁶ Pa (FIG. 14B). An airtight container, inside of which is kept at a high vacuum, is obtained by the step. Note that, as the phosphor film 74, there was used one in which phosphors respectively emitting three primary colors (R, G, B) were arranged in stripe.

Finally, by applying bipolar rectangular pulses with a power of 25 V, a pulse width of 1 msec, and a pulse interval of 10 msec between the electrodes 2 and 3 through the X-directional wiring and the Y-directional wiring, the gap 5 was formed in the conductive film 6 containing carbon as its main constituent (refer to FIG. 12). Thus, the image-forming apparatus 100 (FIG. 48) in this embodiment was manufactured.

In the image-forming apparatus completed as described above, a desired electron-emitting device was selected to be applied with a voltage of 22 V through the X-directional wiring and the Y-directional wiring, and the metal back 73 was applied with a voltage of 8 kV through a high voltage terminal Hv. As a result, a bright and satisfactory image was displayed for a long time.

Embodiment 8

In this embodiment, the same steps as those in Embodiment 7 are implemented from (Step 1) to (Step 6). Hereinafter, (Step 7) and the subsequent steps are described.

(Step 7)

Next, the rear plate 1 manufactured by the steps up through (Step 6) was installed with respect to an ion beam irradiation apparatus shown in FIG. 50, and the polymer film 6′ was subjected to a resistance lowering process by being irradiated with an ion beam. The ion beam irradiation apparatus employs an electron impact type ion source, and is flown with inert gases (desirably Ar) at a pressure of 1×10⁻³ Pa. An acceleration voltage of the ion beam was set to 5 kV, and the ion beam was irradiated through a slit. After the resistance lowering process, the sheet resistance of the conductive film 6 was measured, as a result of which the value was 10⁴ Ω/□.

(Step 8)

The supporting frame 72 and a spacer 101 are adhered onto the rear plate 1 manufactured as described above by means of frit glass. Arrangement is made such that the rear plate 1, which is adhered with the spacer and the supporting frame, and the face plate 71 face to each other (the surface on which the phosphor film 74 and the metal back 73 are formed and the surface on which the wirings 62 and 63 and the like are formed face to each other) (FIG. 14A). Note that frit glass was previously applied to a contact portion on the face plate 71 with the supporting frame 72.

(Step 9)

Next, seal bonding was performed by heating and pressurizing the opposing face plate 71 and rear plate 1 at 400° C. in a vacuum atmosphere at 10⁻⁶ Pa (FIG. 14B). An airtight container, inside of which is kept at a high vacuum, is obtained by the step. Note that, as the phosphor film 74, there was used one in which phosphors respectively emitting three primary colors (R, G, B) were arranged in stripe.

Finally, by applying bipolar rectangular pulses with a power of 25 V, a pulse width of 1 msec, and a pulse interval of 10 msec between the electrodes 2 and 3 through the X-directional wiring and the Y-directional wiring, the gap 5 was formed in the conductive film 6 containing carbon as its main constituent (refer to FIG. 12). Thus, the image-forming apparatus 100 in this embodiment was manufactured.

In the image-forming apparatus completed as described above, a desired electron-emitting device was selected to be applied with a voltage of 22 V through the X-directional wiring and the Y-directional wiring, and the metal back 73 was applied with a voltage of 8 kV through a high voltage terminal Hv. As a result, a bright and satisfactory image was displayed for a long time.

Embodiment 9

In this embodiment, the same steps as those in Embodiment 7 are implemented from (Step 1) to (Step 6). Hereinafter, (Step 7) and the subsequent steps are described.

(Step 7)

Next, the rear plate 1 manufactured by the steps up through (Step 6) is installed in a vacuum baking furnace (not shown), and then is baked at 500° C. in a vacuum at 1×10⁻⁴ Pa for 10 hours, whereby a resistance lowering process is performed to the polymer film 6′ to obtain a conductive film 6. After the resistance lowering process, the sheet resistance of the conductive film 6 was measured, as a result of which the value was 10⁴ Ω/□.

(Step 8)

The supporting frame 72 and a spacer 101 are adhered onto the rear plate 1 manufactured as described above by means of frit glass. Arrangement is made such that the rear plate 1, which is adhered with the spacer and the supporting frame, and the face plate 71 face to each other (the surface on which the phosphor film 74 and the metal back 73 are formed and the surface on which the wirings 62 and 63 and the like are formed face to each other) (FIG. 14A). Note that frit glass was previously applied to a contact portion on the face plate 71 with the supporting frame 72.

(Step 9)

Next, seal bonding was performed by heating and pressurizing the opposing face plate 71 and rear plate 1 at 400° C. in a vacuum atmosphere at 10⁻⁶ Pa (FIG. 14B). An airtight container, inside of which is kept at a high vacuum, is obtained by the step. Note that, as the phosphor film 74, there was used one in which phosphors respectively emitting three primary colors (R, G, B) were arranged in stripe.

Finally, by applying bipolar rectangular pulses with a power of 25 V, a pulse width of 1 msec, and a pulse interval of 10 msec between the electrodes 2 and 3 through the X-directional wiring and the Y-directional wiring, the gap 5 was formed in the conductive film 6 containing carbon as its main constituent (refer to FIG. 12). Thus, the image-forming apparatus 100 in this embodiment was manufactured.

In the image-forming apparatus completed as described above, a desired electron-emitting device was selected to be applied with a voltage of 22 V through the X-directional wiring and the Y-directional wiring, and the metal back 73 was applied with a voltage of 8 kV through a high voltage terminal Hv. As a result, a bright and satisfactory image was displayed for a long time.

Embodiment 10

In this embodiment, the same steps as those in Embodiment 7 are implemented from (Step 1) to (Step 5). Hereinafter, (Step 6) and the subsequent steps are described.

(Step 6)

Prepared is an aqueous solution of cobalt acetate (II) which was prepared with a metal molarity of 5×10⁻² mol/L. The rear plate 1 manufactured by the steps up through (Step 5) was immersed in the aqueous solution for 100 minutes, whereby the metal complex was absorbed into the polymer film 6′. Thereafter, the rear plate was dried at 80° C., thereby obtaining the polyamide acid polymer film 6′ containing cobalt (II) ions.

(Step 7)

Next, the rear plate 1 manufactured by the steps up through (Step 6) is installed in a vacuum baking furnace (not shown), and then is baked at 500° C. in a vacuum at 1×10⁻⁴ Pa for 10 hours, whereby a resistance lowering process is performed to the polymer film 6′. After the resistance lowering process, the sheet resistance of the conductive film 6 was measured, as a result of which the value was 10⁴ Ω/□.

(Step 8)

The supporting frame 72 and a spacer 101 are adhered onto the rear plate 1 manufactured as described above by means of frit glass. Arrangement is made such that the rear plate 1, which is adhered with the spacer and the supporting frame, and the face plate 71 face to each other (the surface on which the phosphor film 74 and the metal back 73 are formed and the surface on which the wirings 62 and 63 and the like are formed face to each other) (FIG. 14A). Note that frit glass was previously applied to a contact portion on the face plate 71 with the supporting frame 72.

(Step 9)

Next, seal bonding was performed by heating and pressurizing the opposing face plate 71 and rear plate 1 at 400° C. in a vacuum atmosphere at 10⁻⁶ Pa (FIG. 14B). An airtight container, inside of which is kept at a high vacuum, is obtained by the step. Note that, as the phosphor film 74, there was used one in which phosphors respectively emitting three primary colors (R, G, B) were arranged in stripe.

Finally, by applying bipolar rectangular pulses with a power of 25 V, a pulse width of 1 msec, and a pulse interval of 10 msec between the electrodes 2 and 3 through the X-directional wiring and the Y-directional wiring, the gap 5 was formed in the conductive film 6 containing carbon as its main constituent (refer to FIG. 12). Thus, the image-forming apparatus 100 in this embodiment was manufactured.

In the image-forming apparatus completed as described above, a desired electron-emitting device was selected to be applied with a voltage of 22 V through the X-directional wiring and the Y-directional wiring, and the metal back 73 was applied with a voltage of 8 kV through a high voltage terminal Hv. As a result, a bright and satisfactory image was displayed for a long time.

According to the manufacturing method of the present invention, the manufacturing process of the electron-emitting device can be simplified, and also, the image forming apparatus excellent in display quality that is kept for a long time can be manufactured at low cost.

What is claimed is:

1. A method for manufacturing an electron-emitting device, the method comprising the steps of:
(A) providing a substrate on which a pair of electrodes and a polymer film of connecting the pair of electrodes are arranged, wherein the polymer film contains a polymer and a substance with a characteristic of light absoption;
(B) irradiating light to the polymer film, to lower resistance of the polymer film; and
(C) forming a gap in a film obtained by lowering the resistance of the polymer film.

2. The method of manufacturing the electron-emitting device according to claim 1, wherein the step of (A) further comprising a step of applying a solution containing a precursor of the polymer and the substance on the substrate.

3. The method of manufacturing the electron-emitting device according to claim 2, wherein the precursor of the polymer contains polyamide acid.

4. A method for manufacturing an electron-emitting device, the method comprising the steps of:
(A) providing a substrate on which a pair of electrodes, a polymer film of connecting the pair of electrodes and a layer containing a substance with a characteristic of light absorption on the polymer film are arranged;
(B) irradiating light to the layer and the polymer film to lower resistance of the polymer film; and
(C) forming a gap in a film obtained by lowering the resistance of the polymer film.

5. A method for manufacturing an electron-emitting device, the method comprising the steps of:
(A) forming a pair of electrodes in first and second regions on a substrate, respectively;
(B) providing a layer containing a substance with a characteristic of light absorption between the regions;
(C) providing a polymer film connecting the electrodes;
(D) irradiating light to the polymer film and the layer, to lower resistance of the polymer film; and
(E) forming a gap in a film obtained by lowering the resistance of the polymer film.

6. The method of manufacturing the electron-emitting device according to claim 4, wherein any one selected from the group consisting of non-metal having an optical absorption edge, a semiconductor, a multi-compound semiconductor, an insulator, and a material having an optical trap level in a band gap is used as the substance.

7. The method of manufacturing the electron-emitting device according to claim 5, wherein any one selected from the group consisting of non-metal having an optical absorption edge, a semiconductor, a multi-compound semiconductor, an insulator, and a material having an optical trap level in a band gap is used as the substance.

8. A method for manufacturing an electron-emitting device, the method comprising the steps of:
(A) providing a pair of electrodes on a substrate having characteristic of light absorption;
(B) providing a polymer film connecting the electrodes;
(C) irradiating light to the polymer film to lower resistance of the polymer film; and
(D) forming a gap in a film obtained by lowering the resistance of the polymer film.

9. The method of manufacturing the electron-emitting device according to claim 1, wherein the light is a laser beam or light emitted from a xenon lamp or halogen lamp.

10. The method of manufacturing the electron-emitting device according to claim 4, wherein the light is a laser beam or light emitted from a xenon lamp or halogen lamp.

11. The method of manufacturing the electron-emitting device according to claim 5, wherein the light is a laser or light emitted from a xenon lamp or halogen lamp.

12. The method of manufacturing the electron-emitting device according to claim 8, wherein the light is a laser or light emitted from a xenon lamp or halogen lamp.

13. A method of manufacturing an electron source having a plurality of electron-emitting devices, wherein the plurality of electron-emitting devices are manufactured in accordance with the method according to claim 1.

14. A method of manufacturing an electron source having a plurality of electron-emitting devices, wherein the plurality of electron-emitting devices are manufactured in accordance with the method according to claim 4.

15. A method of manufacturing an electron source having a plurality of electron-emitting devices, wherein the plurality of electron-emitting devices are manufactured in accordance with the method according to claim 5.

16. A method of manufacturing an electron source having a plurality of electron-emitting devices, wherein the plurality of electron-emitting devices are manufactured in accordance with the method according to claim 8.

17. A method of manufacturing an image-forming apparatus including: an electron source having a plurality of electron-emitting devices; and an image-forming member for forming an image with irradiation of electrons emitted from the electron source, wherein the electron source is manufactured in accordance with the method according to claim 13.

18. A method of manufacturing an image-forming apparatus including: an electron source having a plurality of electron-emitting devices; and an image-forming member for forming an image with irradiation of electrons emitted from the electron source, wherein the electron source is manufactured in accordance with the method according to claim 14.

19. A method of manufacturing an image-forming apparatus including: an electron source having a plurality of electron-emitting devices; and an image-forming member for forming an image with irradiation of electrons emitted from the electron source, wherein the electron source is manufactured in accordance with the method according to claim 15.

20. A method of manufacturing an image-forming apparatus including: an electron source having a plurality of electron-emitting devices; and an image-forming member for forming an image with irradiation of electrons emitted from the electron source, wherein the electron source is manufactured in accordance with the method according to claim 16.

21. A method for manufacturing an electron-emitting device, the method comprising the steps of:
(A) providing a substrate on which a polymer film, containing a polymer and a substance expediting thermal decomposition of the polymer, is arranged;
(B) irradiating an energy beam to the polymer film to lower resistance of the polymer film; and
(C) forming a gap in a film obtained by lowering the resistance of the polymer film.

22. The method of manufacturing the electron-emitting device according to claim 21, wherein the energy beam is selected from the group consisting of an electron beam, an ion beam, condensed light, and laser beam.

23. The method of manufacturing the electron-emitting device according to claim 21, wherein the substance contains metal.

24. The method of manufacturing the electron-emitting device according to claim 23, wherein the metal is selected from a group consisting of Pt, Pd, Ru, Cr. Ni, Co, Ag, In, Cu, Fe, Zn, and Sn.

25. A method of manufacturing a display including a plurality of electron-emitting devices and a light emitting member for emitting light due to electrons emitted from the plurality of electron-emitting devices, wherein the plurality of electron-emitting devices are manufactured in accordance with the method according to claim 21.

26. A method for manufacturing an electron-emitting device, the method comprising the steps of:
(A) providing a substrate on which a polymer film is disposed;
(B) causing the polymer film to absorb a substance expediting a thermal decomposition of the polymer;
(C) lowering resistance of the polymer film containing the substance; and
(D) forming a gap in a film obtained by lowering the resistance of the polymer film containing the substance.

27. The method of manufacturing the electron-emitting device according to claim 26, wherein the step (C) further includes a step of baking the polymer film containing the substance.

28. The method of manufacturing the electron-emitting device according to claim 26, wherein the step (C) further includes a step of irradiating an energy beam to the polymer film containing the substance from a position apart from the substrate.

29. The method of manufacturing the electron-emitting device according to claim 28, wherein the energy beam is selected from the group consisting of light, a laser beam, an electron beam, and an ion beam.

30. The method of manufacturing the electron-emitting device according to claim 26, wherein the step (B) further includes a step of making the polymer film contact with a liquid containing a metal complex.

31. The method of manufacturing the electron-emitting device according to claim 26, wherein the step B further comprising a step of exposing the polymer film in a metal vapor.

32. The method of manufacturing the electron-emitting device according to claim 30, wherein the metal is selected from the group consisting of Pt, Pd, Ru, Cr, Ni, Co, Ag, In, Cu, Fe, Zn, and Sn.

33. A method of manufacturing the display including a plurality of electron-emitting devices and a light emitting member for emitting light due to electrons emitted from the plurality of electron-emitting devices, wherein the plurality of electron-emitting devices are manufactured in accordance with the method according to claim 26.

34. A method for manufacturing an electron-emitting device, the method comprising the steps of:
(A) providing a substrate on which a polymer film, containing a polymer and a substance expediting a thermal decomposition of the polymer, is arranged; and
(B) irradiating an energy beam to the polymer film, to lower resistance of the polymer film.

35. A method for manufacturing an electron-emitting device, the method comprising the steps of:
(A) providing a polymer film contains a polymer and a substance with a characteristic of light absorption;
(B) irradiating light to the polymer film, to lower resistance of the polymer film.
